(19) United States
(12) Patent Application Publication
(10) Pub. No.: US 2025/0212121 A1
(43) Pub. Date: Jun. 26, 2025

(54) NETWORK ENERGY SAVING METHODS, CELL WAKEUP METHODS, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Shukun WANG, Dongguan (CN); Ning YANG, Dongguan (CN); Zhongda DU, Dongguan (CN); Cong SHI, Dongguan (CN)

(21) Appl. No.: 19/077,386

(22) Filed: Mar. 12, 2025

Related U.S. Application Data
(63) Continuation of application No. PCT/CN2022/119052, filed on Sep. 15, 2022.

(51) Int. Cl. H04W 52/02; H04W 36/08

(52) U.S. Cl. CPC H04W 52/0229; H04W 36/08

(57) ABSTRACT

A network energy saving method includes: receiving first indication information transmitted by a target cell, wherein the first indication information is used to indicate that the target cell will enter an energy saving state. In the embodiments of the present disclosure, the energy saving state is introduced for the target cell, which can reduce energy consumption of the network device configured to provide the target cell. In addition, when the target cell is determined to enter the energy saving state, the terminal device receives the first indication information transmitted by the target cell indicating that the target cell will enter the energy saving state, which can ensure that the terminal device knows the state of the target cell in time, thereby avoiding a case that a communication failure occurs because the terminal device does not know that the target cell enters the energy saving state.

### CROSS-REFERENCE TO RELATED APPLICATION

This application is a Continuation Application of International Application No. PCT/CN2022/119052 filed Sep. 15, 2022, which is incorporated herein by reference in its entirety.

### TECHNICAL FIELD

Embodiments of the present disclosure relate to the field of communications, and in particular, to network an energy saving method, a cell wakeup method, a terminal device, and a network device.

### BACKGROUND

Network devices in the 5-th generation mobile communication technology (5-generation, 5G) have large bit rates and high power consumption, and power consumption of a single network device usually reaches four times that of 4G. In addition, as traffics become more complex and diverse, network architectures are also developing in a diverse manner, such as a space-air-ground integrated network architecture. Therefore, energy consumption of network devices in the future 6-th generation mobile communication technology (6-generation, 6G) will become greater. However, excessive energy consumption of the network device will bring huge network operation and maintenance costs to operators' network operations. Therefore, how to reduce the energy consumption of the network device is a technical problem that needs to be solved urgently in this field.

### SUMMARY

In a first aspect, the embodiments of the present disclosure provide a network energy saving method, which is applicable to a terminal device, and the method includes: receiving first indication information transmitted by a target cell, where the first indication information is used to indicate that the target cell will enter an energy saving state.

In a second aspect, the embodiments of the present disclosure provide a cell wakeup method, which is applicable to a terminal device, and the method includes:
transmitting a wakeup request, where the wakeup request is used to request to wake up a target cell in an energy saving state.

In a third aspect, the embodiments of the present disclosure provide a network energy saving method, which is applicable to a network device, the network device is configured to provide a target cell, and the method includes:
transmitting first indication information to a terminal device, where the first indication information is used to indicate that the target cell will enter an energy saving state.

In a fourth aspect, the embodiments of the present disclosure provide a cell wakeup method, which is applicable to a network device, the network device is configured to provide a target cell, and the method includes:
receiving a wakeup request, where the wakeup request is used to request to wake up the target cell in an energy saving state; and waking up the target cell based on the wakeup request.

In a fifth aspect, the embodiments of the present disclosure provide a network energy saving method, which is applicable to a network device, the network device is configured to provide a service cell for a terminal device, and the method includes:
receiving configuration information of a target cell transmitted by the target cell, where the configuration information of the target cell includes at least one of:
information used to indicate a frequency point of the target cell;
information used to indicate a slice supported by the target cell;
a system information of the target cell;
information configured for a wakeup request for waking up the target cell;
a timing deviation between the service cell and the target cell; or information used to identify whether to be close to the target cell.

In a sixth aspect, the embodiments of the present disclosure provide a cell wakeup method, which is applicable to a network device, the network device is configured to provide a service cell for a terminal device, and the method includes:
receiving a wakeup request transmitted by the terminal device, where the wakeup request is used to request to wake up a target cell in an energy saving state; and
forwarding the wakeup request to the target cell.

In a seventh aspect, the embodiments of the present disclosure provide a terminal device configured to perform the methods in the first aspect to the second aspect mentioned above or their respective implementations. Specifically, the terminal device includes a functional module configured to perform the method in any one of the first aspect to the second aspect mentioned above or their respective implementations.

In one implementation, the terminal device may include a processing unit configured to perform functions related to information processing. For example, the processing unit may be a processor.

In one implementation, the terminal device may include a transmitting unit and/or a receiving unit. The transmitting unit is configured to perform functions related to transmitting, and the receiving unit is configured to perform functions related to receiving. For example, the transmitting unit may be a transmitter or an emitter, and the receiving unit may be a receiver or an acceptor. For another example, the terminal device is a communication chip, the transmitting unit may be an input circuit or interface of the communication chip, and the transmitting unit may be an output circuit or interface of the communication chip.

In an eighth aspect, the embodiments of the present disclosure provide a network device configured to perform the methods in the third aspect to the sixth aspect mentioned above or their respective implementations. Specifically, the network device includes a functional module configured to perform the method in any one of the third aspect to the sixth aspect mentioned above or their respective implementation.

In one implementation, the network device may include a processing unit configured to perform functions related to information processing. For example, the processing unit may be a processor.

In one implementation, the network device may include a transmitting unit and/or a receiving unit. The transmitting unit is configured to perform functions related to transmitting, and the receiving unit is configured to perform functions related to receiving. For example, the transmitting unit may be a transmitter or an emitter, and the receiving unit may be a receiver or an acceptor. For another example, the network device is a communication chip, the receiving unit may be an input circuit or interface of the communication chip, and the transmitting unit may be an output circuit or interface of the communication chip.

In a ninth aspect, the embodiments of the present disclosure provide a terminal device, including a transceiver, a processor, and a memory. The memory is configured to store a computer program, and the processor is configured to call and run the computer program stored in the memory, to cause the transceiver and/or the processor to perform the method in any one of the first aspect to the second aspect mentioned above or their respective implementations.

In one implementation, the number of the processor is one or more, and the number of the memory is one or more.

In one implementation, the memory may be integrated with the processor, or the memory may be set separately from the processor.

In one implementation, the transceiver includes a transmitter (emitter) and a receiver (acceptor).

In a tenth aspect, the embodiments of the present disclosure provide a network device, including a transceiver, a processor, and a memory. The memory is configured to store a computer program, and the processor is configured to call and run the computer program stored in the memory, to cause the transceiver and/or the processor to perform the method in any one of the third aspect to the sixth aspect mentioned above or their respective implementations.

In one implementation, the number of the processor is one or more, and the number of the memory is one or more.

In one implementation, the memory may be integrated with the processor, or the memory may be set separately from the processor.

In one implementation, the transceiver includes a transmitter (emitter) and a receiver (acceptor).

In an eleventh aspect, the embodiments of the present disclosure provide a chip configured to implement the method in any one of the first aspect to the sixth aspect mentioned above or their respective implementations. Specifically, the chip includes: a processor configured to call a computer program from a memory and run the computer program, to cause a device equipped with the chip to perform the method in any one of the first aspect to the sixth aspect mentioned above or their respective implementations.

In the twelfth aspect, the embodiments of the present disclosure provide a non-transitory computer-readable storage medium configured to store a computer program, and the computer program causes a computer to perform the method in any one of the first aspect to the sixth aspect mentioned above or their respective implementations.

In a thirteenth aspect, the embodiments of the present disclosure provide a computer program product, including computer program instructions, which cause a computer to perform the method in any one of the first aspect to the sixth aspect mentioned above or their respective implementations.

In a fourteenth aspect, the embodiments of the present disclosure provide a computer program, and the computer program, when executed on a computer, causes the computer to perform the method in any one of the first aspect to the sixth aspect mentioned above or their respective implementations.

### BRIEF DESCRIPTION OF THE DRAWINGS

FIG. 1 is an example of a system framework provided by the embodiments of the present disclosure.

FIG. 2 is a schematic flowchart of a network energy saving method provided by the embodiments of the present disclosure.

FIG. 3 is another schematic flowchart of a network energy saving method provided by the embodiments of the present disclosure.

FIG. 4 is a schematic flowchart of a cell wakeup method provided by the embodiments of the present disclosure.

FIG. 5 is another schematic flowchart of a cell wakeup method provided by the embodiments of the present disclosure.

FIG. 6 is another schematic flowchart of a cell wakeup method provided by the embodiments of the present disclosure.

FIG. 7 is a schematic flowchart of a method for waking up a target cell by transmitting a wakeup request to the target cell in a case of the absence of a downlink discovery signal, provided by the embodiments of the present disclosure.

FIG. 8 is a schematic flowchart of a method for waking up a target cell by transmitting a wakeup request to a service cell of a terminal device in a case of the absence of a downlink discovery signal, provided by the embodiments of the present disclosure.

FIG. 9 is a schematic flowchart of a method for waking up a target cell by transmitting a wakeup request to the target cell in a case of the presence of a downlink discovery signal, provided by the embodiments of the present disclosure.

FIG. 10 is a schematic flowchart of a method for waking up a target cell by transmitting a wakeup request to a service cell of a terminal device in a case of the presence of a downlink discovery signal, provided by the embodiments of the present disclosure.

FIG. 11 is a schematic block diagram of a terminal device provided by the embodiments of the present disclosure.

FIG. 12 is another schematic block diagram of a terminal device provided by the embodiments of the present disclosure.

FIG. 13 is a schematic block diagram of a network device configured to provide a target cell provided by the embodiments of the present disclosure.

FIG. 14 is a schematic block diagram of a network device configured to provide a target cell provided by the embodiments of the present disclosure.

FIG. 15 is a schematic block diagram of a network device configured to provide a target cell provided by the embodiments of the present disclosure.

FIG. 16 is a schematic block diagram of a network device configured to provide a target cell provided by the embodiments of the present disclosure.

FIG. 17 is a schematic block diagram of a communication device provided by the embodiments of the present disclosure.

FIG. 18 is a schematic block diagram of a chip provided by the embodiments of the present disclosure.

### DETAILED DESCRIPTION

Technical solutions in the embodiments of the present disclosure will be described below with reference to the drawings.

It should be noted that the term “predefined” or “preset” may be implemented by pre-saving corresponding codes, tables or other manners that may be used to indicate related information, in the device (for example, including the terminal device and the network device), and the present disclosure does not limit its specific implementation. For example, the preset may refer to what is defined in a protocol. Optionally, the “protocol” may refer to a standard protocol in the communication field, for example, it may include an LTE protocol, an NR protocol, and related protocols applied in future communication systems, which is not specifically limited in this disclosure.

Furthermore, the term “indication or its variants” may be a direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B. The term “correspondence or its variants” may mean that there is a direct correspondence or indirect correspondence between the two, it may also mean that there is an associated relationship between the two, or it may also mean a relationship of indicating and being indicated or a relationship of configuring and being configured, etc. In addition, the description “when . . . ” involved in the embodiments of the present disclosure may be interpreted as “if” or “in a case of/where” or “upon/while . . . ” or “in response to/that”. Similarly, the phrase “if determining (the stated condition or event)” or “if detecting (the stated condition or event)” may be explained as “when/upon/while determining (the stated condition or event)” or “in response to determining (the stated condition or event)” or “when/upon/while detecting (the stated condition or event)” or “in response to detecting (the stated condition or event)”, depending on the context. The term “predefined” or “predefined rule” may be implemented by pre-saving corresponding codes, tables or other manners that may be used to indicate related information, in the device (for example, including the terminal device and the network device), and the present disclosure does not limit its specific implementation. For example, the preset may refer to what is defined in a protocol. It should also be understood that in the embodiments of the present disclosure, the “protocol” may refer to a standard protocol in the communication field, for example, it may include an LTE protocol, an NR protocol, and related protocols applied in future communication systems, which is not specifically limited in this disclosure. In addition, in the embodiments of the present disclosure, the term “and/or” is only an association relationship to describe associated objects, meaning that there may be three kinds of relationships. Specifically, A and/or B may mean three cases where: A exists alone, both A and B exist, and B exists alone. In addition, a character “/” herein generally means that related objects before and after “/” are in an “or” relationship.

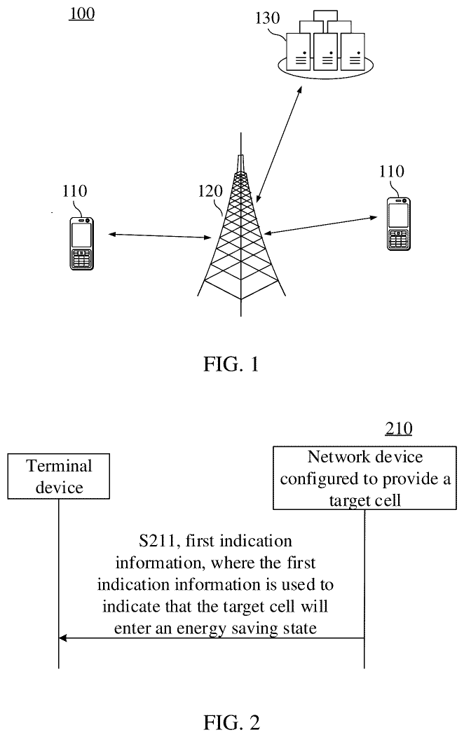

FIG. 1 is an example of a system framework provided by the embodiments of the present disclosure.

As shown in FIG. 1, a communication system 100 may include a terminal device 110 and a network device 120. The network device 120 may communicate with the terminal device 110 via an air interface. Multi-service transmissions are supported between the terminal device 110 and the network device 120.

It should be understood that the embodiments of the present disclosure are only illustrated exemplarily by the communication system 100, but the embodiments of the present disclosure are not limited thereto. That is, the technical solutions of the embodiments of the present disclosure may be applied to various communication systems, such as: a long term evolution (Long Term Evolution, LTE) system, an LTE time division duplex (Time Division Duplex, TDD), a universal mobile telecommunication system (Universal Mobile Telecommunication System, UMTS), an internet of things (Internet of Things, IoT) system, a narrow band internet of things (Narrow Band Internet of Things, NB-IoT) system, an enhanced machine-type communication (enhanced Machine-Type Communications, eMTC) system, a 5G communication system (also known as new radio (New Radio, NR) communication system), or future communication systems, etc.

In the communication system 100 shown in FIG. 1, the network device 120 may be an access network device that communicates with the terminal device 110. The access network device may provide communication coverage for a specific geographical area, and may communicate with the terminal device 110 (e.g., UE) located in the coverage area.

The network device 120 may be an evolutional base station (Evolutional Node B, eNB or eNodeB) in a long term evolution (LTE) system, or a next generation radio access network (Next Generation Radio Access Network, NG RAN) device, or a base station (gNB) in an NR system, or a wireless controller in a cloud radio access network (Cloud Radio Access Network, CRAN), or the network device 120 may be a relay station, an access point, a vehicle-mounted device, a wearable device, a hub, a switch, a network bridge, a router, or a network device in a public land mobile network (Public Land Mobile Network, PLMN) evolved in the future, etc.

The terminal device 110 may be any terminal device, including but not limited to a terminal device connected to the network device 120 or other terminal devices by a wired connection or a wireless connection.

For example, the terminal device 110 may refer to an access terminal, a user equipment (User Equipment, UE), a user unit, a user station, a mobile station, a mobile platform, a remote station, a remote terminal, a mobile device, a user terminal, a terminal, a wireless communication device, a user agent or a user apparatus. The access terminal may be a cellular phone, a cordless phone, a session initiation protocol (SIP) phone, an IoT device, a satellite handheld terminal, a wireless local loop (WLL) station, a personal digital assistant (Personal Digital Assistant, PDA), a handheld device with a wireless communication function, a computing device with a wireless communication function or other processing device connected to a wireless modem, a vehicle-mounted device, a wearable device, a terminal device in the 5G network, or a terminal device in a future evolved network, etc.

The terminal device 110 may be used for device-to-device (D2D) communication. The wireless communication system 100 may also include a core network device 130 that communicates with the base station. The core network device 130 may be a 5G core network (5G Core, 5GC) device, for example, an access and mobility management function (Access and Mobility Management Function, AMF), or an authentication server function (Authentication Server Function, AUSF), or a user plane function (User Plane Function, UPF), or a session management function (Session Management Function, SMF). Optionally, the core network device 130 may also be an evolved packet core (Evolved Packet Core, EPC) device of the LTE network, for example, a session management function+core packet gateway (Session Management Function+Core Packet Gateway, SMF+PGW-C) device. It should be understood that the SMF+PGW-C may simultaneously implement the functions that the SMF and PGW-C can implement. In the network evolution process, the core network device mentioned above may also be called other names, or a new network entity may be formed by dividing the functions of the core network, which is not limited in the embodiments of the present disclosure.

The functional units in the communication system 100 may also establish connections via next generation (NG) network interfaces to achieve communications.

For example, the terminal device establishes an air interface connection with the access network device via the NR interface, for transmitting user plane data and control plane signaling; the terminal device may establish a control plane signaling connection with the AMF via the NG interface 1 (N1, for short); the access network device, such as the next generation wireless access base station (gNB), may establish a user plane data connection with the UPF via the NG interface 3 (N3, for short); the access network device may establish a control plane signaling connection with the AMF via the NG interface 2 (N2, for short); the UPF may establish a control plane signaling connection with the SMF via the NG interface 4 (N4, for short); the UPF may exchange user plane data with the data network via the NG interface 6 (N6, for short); the AMF may establish a control plane signaling connection with the SMF via the NG interface 11 (N11, for short); the SMF may establish a control plane signaling connection with the PCF via the NG interface 7 (N7, for short).

FIG. 1 exemplarily shows a base station, a core network device and two terminal devices. Optionally, the wireless communication system 100 may include multiple base station devices and a coverage range within each base station may include another number of terminal devices, which is not limited in the present disclosure. It should be understood that any device with a communication function in the network/system in the embodiments of the present disclosure may be referred to as a communication device. Taking the communication system 100 shown in FIG. 1 as an example, the communication device may include a network device 120 and a terminal device 110 with a communication function. The network device 120 and the terminal device 110 may be the devices described above and will not be repeated here; the communication device may also include other devices in the communication system 100, such as a network controller, a mobile management entity and other network entities, which is not limited in the embodiments of the present disclosure. It should be understood that the terms “system” and “network” are often used interchangeably herein. The term “and/or” herein is only an association relationship to describe associated objects, meaning that there may be three kinds of relationships, and for example, A and/or B may mean three cases where: A exists alone, both A and B exist, and B exists alone. In addition, a character “/” herein generally means that related objects before and after “/” are in an “or” relationship.

It is worth noting that network devices in the 5-th generation mobile communication technology (5-generation, 5G) have large bit rates and high power consumption, and power consumption of a single network device usually reaches four times that of 4G. In addition, as traffics become more complex and diverse, network architectures are also developing in a diverse manner, such as a space-air-ground integrated network architecture. Therefore, energy consumption of network devices in the future 6-th generation mobile communication technology (6-generation, 6G) will become greater. However, excessive energy consumption of the network device will bring huge network operation and maintenance costs to operators' network operations. Therefore, how to reduce the energy consumption of the network device is a technical problem that needs to be solved urgently in this field.

In view of this, the embodiments of the present disclosure provide a network energy saving method, a cell wakeup method, a terminal device and a network device, which can reduce energy consumption of the network device.

According to a first aspect of the present disclosure, a network energy saving method is provided. The method is applicable to a terminal device and includes:
receiving first indication information transmitted by a target cell, wherein the first indication information is used to indicate that the target cell will enter an energy saving state.

In some embodiments, the terminal device is in a connected state; and the method further includes:
switching a service cell of the terminal device from the target cell to a neighboring cell of the target cell.

In some embodiments, the terminal device is in an inactive state or an idle state; and the method further includes:
performing a cell reselection operation.

In some embodiments, the first indication information is carried in a paging message, or the first indication information is carried in a changed system message, or the first indication information indicates, via a specific downlink signal, that the target cell will enter the energy saving state.

In some embodiments, in a case where the first indication information is carried in the changed system message, the method further includes:
receiving second indication information transmitted by the target cell, wherein the second indication information is used to indicate the terminal device to receive the changed system message.

In some embodiments, the first indication information includes at least one of:
information, used to indicate a frequency on which the terminal device preferentially resides;
duration information, used to indicate a duration between a moment when the terminal device receives the first indication information and a moment when the target cell enters the energy saving state; or
moment information, used to indicate a moment when the target cell enters the energy saving state.

In some embodiments, the moment information is used to indicate a target time unit, and the moment when the target cell enters the energy saving state is a start moment or an end moment of the target time unit.

In some embodiments, the energy saving state means: prohibiting the target cell from performing an uplink reception or prohibiting the target cell from receiving an uplink reception except a wakeup request for waking up the target cell, and prohibiting the target cell from performing a downlink transmission.

In some embodiments, the energy saving state means: prohibiting the target cell from performing an uplink reception or prohibiting the target cell from receiving an uplink reception except a wakeup request for waking up the target cell, and prohibiting the target cell from transmitting a downlink transmission except a downlink discovery signal.

In some embodiments, a coverage-type cell in which the target cell is located is a service cell of the terminal device, or the target cell is a capacity-type cell under a service cell of the terminal device.

According to a second aspect of the present disclosure, a cell wakeup method is provided.

The method is applicable to a terminal device, and the method includes:
transmitting a wakeup request, wherein the wakeup request is used to request to wake up a target cell in an energy saving state.

In some embodiments, transmitting the wakeup request includes:
transmitting the wakeup request to the target cell.

In some embodiments, the wakeup request requests to wake up the target cell by a ZC sequence or a preamble code.

In some embodiments, the ZC sequence used by the wakeup request is different from a ZC sequence used by the target cell, or a root sequence used to generate the ZC sequence used by the wakeup request is different from a root sequence used by a neighboring cell of the target cell.

In some embodiments, the terminal device is in a connected state, and transmitting the wakeup request includes:
transmitting the wakeup request to a service cell of the terminal device.

In some embodiments, the wakeup request carries identifier information of the target cell.

In some embodiments, the identifier information includes at least one of: a physical cell identifier (PCI) of the target cell, a frequency point of the target cell, and a cell identifier of the target cell.

In some embodiments, transmitting the wakeup request includes:
transmitting the wakeup request, when the terminal device is close to the target cell and the terminal device expects to wake up the target cell.

In some embodiments, the method further includes:
determining that the terminal device is close to the target cell, when beam quality of a service cell of the terminal device is greater than or equal to a first threshold value, and/or, when signal quality of a synchronization signal and/or physical broadcast channel block (SSB) of the service cell is greater than or equal to a second threshold value.

In some embodiments, the method further includes:
determining that the terminal device expects to wake up the target cell, when a priority of a frequency of the target cell is greater than a priority of a frequency of a service cell of the terminal device, and/or when a slice supported by the target cell is a slice expected by the terminal device.

In some embodiments, transmitting the wakeup request, when the terminal device is close to the target cell and the terminal device expects to wake up the target cell, includes: receiving a downlink discovery signal transmitted by the target cell; and transmitting the wakeup request, when the terminal device is close to the target cell, quality of the downlink discovery signal meets a wakeup requirement, and the target cell and the terminal device expect to wake up the target cell.

In some embodiments, the method further includes:
determining that the quality of the downlink discovery signal meets the wakeup requirement, when the quality of the downlink discovery signal is greater than or equal to a third threshold value.

In some embodiments, the energy saving state means: prohibiting the target cell from performing an uplink reception or prohibiting the target cell from receiving an uplink reception except the wakeup request, and prohibiting the target cell from performing a downlink transmission.

In some embodiments, the energy saving state means: prohibiting the target cell from performing an uplink reception or prohibiting the target cell from receiving an uplink reception except the wakeup request, and prohibiting the target cell from transmitting a downlink signal or downlink information except a downlink discovery signal.

In some embodiments, the method further includes:
performing a cell selection operation and/or a cell reselection operation at an interval of a first duration after transmitting the wakeup request.

In some embodiments, performing the cell selection operation and/or the cell reselection operation at the interval of the first duration after transmitting the wakeup request, includes: after transmitting the wakeup request, starting a timer with a duration equal to the first duration;
if the timer times out, performing the cell selection operation and/or the cell reselection operation.

In some embodiments, the first duration is determined by the terminal device, or the first duration is a duration configured by a network device, or the first duration is a predefined duration, or the first duration depends on an implementation of the terminal device.

In some embodiments, performing the cell selection operation and/or the cell reselection operation at the interval of the first duration after transmitting the wakeup request, includes: receiving a synchronization signal and a system message transmitted by the target cell, at the interval of the first duration after transmitting the wakeup request;
performing the cell selection operation and/or the cell reselection operation based on the synchronization signal and the system message.

In some embodiments, the method further includes:
receiving configuration information of the target cell transmitted by a service cell of the terminal device, wherein the configuration information of the target cell includes at least one of: information used to indicate a frequency point of the target cell;
information used to indicate a slice supported by the target cell;
a system message of the target cell;
configuration information of the wakeup request;
a timing deviation between the service cell and the target cell; or configuration information used to identify whether to be close to the target cell.

In some embodiments, the configuration information of the wakeup request includes information used to generate the wakeup request and/or information used to configure a time-frequency resource of the wakeup request, and the information used to generate the wakeup request includes at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

In some embodiments, the configuration information used to identify whether to be close to the target cell, includes at least one of: an identifier of a beam of the service cell, an identifier of an SSB of the service cell, a threshold value corresponding to the identifier of the beam of the service cell, or a threshold value corresponding to the identifier of the SSB of the service cell.

In some embodiments, a coverage-type cell in which the target cell is located is a service cell of the terminal device, or the target cell is a capacity-type cell under a service cell of the terminal device.

According to a third aspect of the present disclosure, a network energy saving method is provided. The method is applicable to a network device, the network device is configured to provide a target cell, and the method includes:
transmitting first indication information to a terminal device, wherein the first indication information is used to indicate that the target cell will enter an energy saving state.

In some embodiments, the first indication information is carried in a paging message, or the indication information is carried in a changed system message, or the first indication information indicates, via a specific downlink signal, that the target cell will enter the energy saving state.

In some embodiments, in a case where the first indication information is carried in the changed system message, the method further includes:
transmitting second indication information to the terminal device, wherein the second indication information is used to indicate the terminal device to receive the changed system message.

In some embodiments, the first indication information includes at least one of:
information, used to indicate a frequency on which the terminal device preferentially resides;
duration information, used to indicate a duration between a moment when the terminal device receives the first indication information and a moment when the target cell enters the energy saving state; or
moment information, used to indicate a moment when the target cell enters the energy saving state.

In some embodiments, the moment information is used to indicate a target time unit, and the moment when the target cell enters the energy saving state is a start moment or an end moment of the target time unit.

In some embodiments, the method further includes:
transmitting configuration information of the target cell to a service cell of the terminal device, wherein the configuration information of the target cell includes at least one of: information used to indicate a frequency point of the target cell;
information used to indicate a slice supported by the target cell;
a system message of the target cell;
information configured for a wakeup request for waking up the target cell;
a timing deviation between the service cell and the target cell; or information used to identify whether to be close to the target cell.

In some embodiments, the information configured for the wakeup request for waking up the target cell includes information used to generate the wakeup request and/or information used to configure a time-frequency resource of the wakeup request, and the information used to generate the wakeup request includes at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

In some embodiments, the information used to identify whether to be close to the target cell includes at least one of: an identifier of a beam of the service cell, an identifier of an SSB of the service cell, a threshold value corresponding to the identifier of the beam of the service cell, or a threshold value corresponding to the identifier of the SSB of the service cell.

In some embodiments, the energy saving state means: prohibiting the target cell from performing an uplink reception or prohibiting the target cell from receiving an uplink reception except a wakeup request for waking up the target cell, and prohibiting the target cell from performing a downlink transmission.

In some embodiments, the energy saving state means: prohibiting the target cell from performing an uplink reception or prohibiting the target cell from receiving an uplink reception except a wakeup request for waking up the target cell, and prohibiting the target cell from transmitting a downlink transmission except a downlink discovery signal.

In some embodiments, a coverage-type cell in which the target cell is located is a service cell of the terminal device, or the target cell is a capacity-type cell under a service cell of the terminal device.

According to a fourth aspect of the present disclosure, a cell wakeup method is provided. The method is applicable to a network device, the network device is configured to provide a target cell, and the method includes:
receiving a wakeup request, wherein the wakeup request is used to request to wake up the target cell in an energy saving state; and waking up the target cell based on the wakeup request.

In some embodiments, receiving the wakeup request includes:
receiving the wakeup request transmitted by a terminal device.

In some embodiments, the wakeup request requests to wake up the target cell by a ZC sequence or a preamble code.

In some embodiments, the ZC sequence used by the wakeup request is different from a ZC sequence used by the target cell, or a root sequence used to generate the ZC sequence used by the wakeup request is different from a root sequence used by a neighboring cell of the target cell.

In some embodiments, receiving the wakeup request includes:
receiving the wakeup request forwarded by a neighboring cell of the target cell.

In some embodiments, the wakeup request carries identifier information of the target cell.

In some embodiments, the identifier information includes at least one of: a physical cell identifier (PCI) of the target cell, a frequency point of the target cell, and a cell identifier of the target cell.

In some embodiments, the method further includes:
transmitting notification information to a neighboring cell of the target cell, wherein the notification information is used to indicate that the target cell has been woken up.

In some embodiments, the method further includes:
transmitting a synchronization signal and a system message transmitted by the target cell.

In some embodiments, the method further includes:
determining whether to wake up the target cell.

In some embodiments, determining whether to wake up the target cell includes:
determining whether to wake up the target cell based on at least one of:
a deployment location of the target cell, a moment when the wakeup request is received, and a time period of a moment when the wakeup request is received.

In some embodiments, the energy saving state means: prohibiting the target cell from performing an uplink reception or prohibiting the target cell from receiving an uplink reception except the wakeup request, and prohibiting the target cell from performing a downlink transmission.

In some embodiments, the energy saving state means: prohibiting the target cell from performing an uplink reception or prohibiting the target cell from receiving an uplink reception except the wakeup request, and prohibiting the target cell from transmitting a downlink transmission except a downlink discovery signal.

In some embodiments, the method further includes:
transmitting the downlink discovery signal to the terminal device.

In some embodiments, a coverage-type cell in which the target cell is located is a service cell of a terminal device, or the target cell is a capacity-type cell under a service cell of the terminal device.

According to a fifth aspect of the present disclosure, a network energy saving method is provided. The method is applicable to a network device, the network device is configured to provide a service cell for a terminal device, and the method includes:
receiving configuration information of a target cell transmitted by the target cell, wherein the configuration information of the target cell includes at least one of:
information used to indicate a frequency point of the target cell;
information used to indicate a slice supported by the target cell;
a system message of the target cell;
information configured for a wakeup request for waking up the target cell;
a timing deviation between the service cell and the target cell; or information used to identify whether to be close to the target cell.

In some embodiments, the information configured for the wakeup request for waking up the target cell includes information used to generate the wakeup request and/or information used to configure a time-frequency resource of the wakeup request, and the information used to generate the wakeup request includes at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

In some embodiments, the information used to identify whether to be close to the target cell includes at least one of: an identifier of a beam of the service cell, an identifier of an SSB of the service cell, a threshold value corresponding to the identifier of the beam of the service cell, or a threshold value corresponding to the identifier of the SSB of the service cell.

In some embodiments, the method further includes:
forwarding the configuration information of the target cell to the terminal device.

In some embodiments, the energy saving state means: prohibiting the target cell from performing an uplink reception or prohibiting the target cell from receiving an uplink reception except the wakeup request, and prohibiting the target cell from performing a downlink transmission.

In some embodiments, the energy saving state means: prohibiting the target cell from performing an uplink reception or prohibiting the target cell from receiving an uplink reception except the wakeup request, and prohibiting the target cell from transmitting a downlink transmission except a downlink discovery signal.

In some embodiments, a coverage-type cell in which the target cell is located is the service cell of the terminal device, or the target cell is a capacity-type cell under the service cell of the terminal device.

According to a sixth aspect of the present disclosure, a cell wakeup method is provided. The method is applicable to a network device, the network device is configured to provide a service cell for a terminal device, and the method includes:
receiving a wakeup request transmitted by the terminal device, wherein the wakeup request is used to request to wake up a target cell in an energy saving state; and forwarding the wakeup request to the target cell.

In some embodiments, the wakeup request carries identifier information of the target cell.

In some embodiments, the identifier information includes at least one of: a physical cell identifier (PCI) of the target cell, a frequency point of the target cell, and a cell identifier of the target cell.

In some embodiments, the method further includes:
receiving notification information transmitted by the target cell, wherein the notification information is used to indicate that the target cell has been woken up.

In some embodiments, the method further includes:
determining whether to forward the wakeup request to the target cell.

In some embodiments, determining whether to forward the wakeup request to the target cell includes:
determining whether to forward the wakeup request to the target cell based on at least one of:
traffic volume of the service cell, a deployment location of the service cell, a deployment location of the target cell, a moment when the wakeup request is received, and a time period of a moment when the wakeup request is received.

In some embodiments, the energy saving state means: prohibiting the target cell from performing an uplink reception or prohibiting the target cell from receiving an uplink reception except the wakeup request, and prohibiting the target cell from performing a downlink transmission.

In some embodiments, the energy saving state means: prohibiting the target cell from performing an uplink reception or prohibiting the target cell from receiving an uplink reception except the wakeup request, and prohibiting the target cell from transmitting a downlink transmission except a downlink discovery signal.

In some embodiments, the method further includes:
transmitting configuration information of the target cell to the terminal device, wherein the configuration information of the target cell includes at least one of:
information used to indicate a frequency point of the target cell;
information used to indicate a slice supported by the target cell;
a system message of the target cell;
configuration information of the wakeup request;
a timing deviation between the service cell and the target cell; or configuration information used to identify whether to be close to the target cell.

In some embodiments, the configuration information of the wakeup request includes information used to generate the wakeup request and/or information used to configure a time-frequency resource of the wakeup request, and the information used to generate the wakeup request includes at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

In some embodiments, the configuration information used to identify whether to be close to the target cell, includes at least one of: an identifier of a beam of the service cell, an identifier of an SSB of the service cell, a threshold value corresponding to the identifier of the beam of the service cell, or a threshold value corresponding to the identifier of the SSB of the service cell.

In some embodiments, a coverage-type cell in which the target cell is located is the service cell of the terminal device, or the target cell is a capacity-type cell under the service cell of the terminal device.

FIG. 2 is a schematic flowchart of a network energy saving method 210 provided by the embodiments of the present disclosure. The network energy saving method 210 may be interactively performed by a terminal device and a network device configured to provide a target cell. For example, the method may be performed interactively by the terminal device shown in FIG. 1 and the access network device shown in FIG. 1. Of course, the network energy saving method 210 may also be understood as a method interactively performed by the terminal device and the target cell, which is not limited in the present disclosure.

As shown in FIG. 2, the method 210 may include: S211, receiving, by a terminal device, first indication information transmitted by a target cell, where the first indication information is used to indicate that the target cell will enter an energy saving state.

In other words, the terminal device receives the first indication information transmitted by configured to provide the target cell.

Alternatively, the terminal device receives the first indication information transmitted by the network device by the target cell.

Exemplarily, the network device configured to provide the target cell transmits the first indication information to the terminal device at a first moment. Optionally, the first moment is the moment when the network device configured to provide the target cell determines that the target cell enters the energy saving state, or the first moment is before the moment when the network device configured to provide the target cell determines that the target cell enters the energy saving state, or the first moment is the moment when the target cell enters the energy saving state, or the first moment is before the moment when the target cell enters the energy saving state.

In the embodiments of the present disclosure, the energy saving state is introduced for the target cell, which can reduce energy consumption of the network device configured to provide the target cell. In addition, when the target cell is determined to enter the energy saving state, the terminal device receives the first indication information transmitted by the target cell indicating that the target cell will enter the energy saving state, which can ensure that the terminal device knows the state of the target cell in time, thereby avoiding a case that a communication failure occurs because the terminal device does not know that the target cell enters the energy saving state.

It is worth noting that the term “wake up or its variants” involved in this disclosure may also be equivalently replaced by “activate or its variants”, “enable or its variants” or terms with similar meanings, the term “sleep or its variants” may also be equivalently replaced by “deactivate or its variants”, “disable or its variants” or terms with similar meanings, the term “energy saving state” may also be equivalently replaced by a “normal state,” “inactive state,” “disabled state,” “non-active state,” “non-enabled state” or terms with similar meanings, the state of the target cell after being activated may also be referred to as “non-energy saving state”, “active state”, “enabled state” or terms with similar meanings, which is not specifically limited in this disclosure.

In some embodiments, the energy saving state means: prohibiting the target cell from performing an uplink reception or prohibiting the target cell from receiving an uplink reception except a wakeup request for waking up the target cell, and prohibiting the target cell from performing a downlink transmission.

In some embodiments, the energy saving state means: prohibiting the target cell from performing an uplink reception or prohibiting the target cell from receiving an uplink reception except a wakeup request for waking up the target cell, and prohibiting the target cell from transmitting a downlink transmission except a downlink discovery signal.

Exemplarily, the uplink reception may be a reception of an uplink channel or an uplink signal. The uplink channel may include a physical random access channel (Physical Random Access Channel, PRACH), a physical uplink control channel (Physical Uplink Control channel, PUCCH), a physical uplink shared channel (Physical Uplink Shared channel, PUSCH), or the like. The uplink signal may include an uplink demodulation reference signal (Demodulation Reference Signal, DMRS), a sounding reference signal (Sounding Reference Signal, SRS), a phase tracking reference signal (PT-RS), or the like. Herein, the uplink DMRS may be used for the demodulation of the uplink channel, the SRS may be used for the measurement of the uplink channel, the synchronization or phase tracking on the uplink time and frequency, and the PT-RS may also be used for the measurement of the uplink channel, and synchronization or phase tracking on the uplink time and frequency.

Exemplarily, the downlink transmission may be a transmission of a downlink channel or a downlink signal. The downlink channel may include a physical downlink control channel (Physical Downlink Control Channel, PDCCH), a physical downlink shared channel (Physical Downlink Shared Channel, PDSCH), a paging control channel (Paging Control Channel, PCCH), a physical broadcast channel (Physical Broadcast Channel, PBCH), a paging channel (Paging Channel, PCH), a primary common control physical channel (Primary Common Control Physical Channel, P-CCPCH), or the like. The downlink signal may include: a primary synchronization signal (Primary Synchronization Signal, PSS), a secondary synchronization signal (Secondary Synchronization Signal, SSS), a synchronization signal and/or physical broadcast channel block (Synchronization Signal/PBCH Block, SSB), a channel state information reference signal (Channel State Information Reference Signal, CSI-RS) or a downlink demodulation reference signal (Demodulation Reference Signal, DMRS), etc., where the downlink DMRS may be used for the demodulation of the downlink channel. Of course, from the perspective of the transmission of a system message, the downlink transmission may also include a transmission for system information (System Information, SI), a master information block (Master Information Block, MIB) and a system information block (System Information Block, SIB).

Exemplarily, when the target cell is in the energy saving state, the target cell may receive a wakeup request for waking up the target cell, which is transmitted by other cells or a coverage-type cell of the target cell.

Exemplarily, the target cell is prohibited from receiving signals and information from other cells, in the energy saving state.

Exemplarily, the target cell is prohibited from transmitting signals and information to other cells, in the energy saving state.

Exemplarily, the downlink discovery signal is used by the terminal device to discover the target cell.

It is worth noting that the embodiments of the present disclosure do not limit the specific type of the downlink discovery signal. For example, the downlink discovery signal may be an SSB, a CSI-RS or other downlink signals. For example, the downlink signal may also be a reference signal dedicated to discovering the target cell.

It should be understood that the embodiments of the present disclosure may include physical channels or reference signals with the same name as but different functions from those mentioned above, or may also include physical channels or reference signals with different names from but the same function as those mentioned above, which are not limited in the present disclosure. In addition, it should be understood that the terms “downlink” and “uplink” involved in the present disclosure are used to indicate the transmission direction of signals or data, where “downlink” is used to indicate that the transmission direction of signals or data is a direction from the station transmitting to the user equipment of the cell, and “uplink” is used to indicate that the transmission direction of signals or data is a direction from the user equipment of the cell transmitting to the station.

In some embodiments, the terminal device is in a connected state; the method 210 may further include:
switching, by the terminal device, a service cell of the terminal device from the target cell to a neighboring cell of the target cell.

Exemplarily, after the terminal device receives the first indication information, the terminal device switches the service cell of the terminal device from the target cell to the neighboring cell of the target cell. In other words, the first indication information may be used to trigger the terminal device to switch the service cell of the terminal device.

In some embodiments, the terminal device is in an inactive state or an idle state; the method 210 may further include:
performing, by the terminal device, a cell reselection operation.

Exemplarily, after the terminal device receives the first indication information, the terminal device performs the cell reselection operation. In other words, after the terminal device receives the first indication information, the terminal device performs the cell reselection operation to reselect a resident cell of the terminal device. That is, the first indication information may be used to trigger the terminal device to perform the cell reselection operation, or the first indication information may be used to trigger the terminal device to switch the resident cell of the terminal device.

It is worth noting that the radio resource control (RRC) state of the terminal device may include: an RRC inactive (RRC_INACTIVE) state, an RRC idle (RRC_IDLE) state and an RRC connected (RRC_CONNECTED) state.

Herein, for the RRC_CONNECTED state, there is an RRC connection between the network device and the terminal device, and there is a UE AS context between the network device and the terminal device, that is, the network device knows that the location of the terminal device is at a specific cell level, the mobility of the terminal device is controlled by the network device, and unicast data may be transmitted between the network device and the terminal device. For the RRC_IDLE state, there is no UE access stratum (Access Stratum, AS) context or no RRC connection at the network device side, the mobility of the terminal device is implemented based on cell selection and reselection, the paging of the terminal device is initiated by the core network (Core Network, CN), and its paging area is configured by the CN. For the RRC_INACTIVE state, there is a connection between CN-NR, the UE AS context exists on a certain base station, the mobility of the terminal device is implemented based on cell selection and reselection, the paging of the terminal device is triggered by the radio access network (Radio Access Network, RAN), and its paging area is managed by the RAN, and the network device knows that the location of the terminal device is based on a paging area level of the RAN.

In addition, the terminal device may switch or transition between various RRC states. For example, the UE in the RRC_CONNECTED state may enter the RRC_IDLE state by releasing the RRC connection; the UE in the RRC_IDLE state may enter the RRC_CONNECTED state by establishing the RRC connection; the UE in the RRC_CONNECTED state may enter the RRC_INACTIVE state by releasing with suspending the RRC connection; the UE in the RRC_INACTIVE state may enter the RRC_CONNECTED state by resuming the RRC connection, and of course, may also enter the RRC_IDLE state by releasing the RRC connection.

In conjunction with the present disclosure, the non-active state may include: an RRC inactive (RRC_INACTIVE) state, and an RRC idle (RRC_IDLE) state. The active state may include: an RRC connected (RRC_CONNECTED) state; in other words, the terminal device in the non-active state means that: the RRC state of the terminal device is the RRC inactive (RRC_INACTIVE) state or the RRC idle (RRC_IDLE) state; the terminal device in the idle state means that: the RRC state of the terminal device is the RRC idle (RRC_IDLE) state.

In some embodiments, the first indication information is carried in a paging message, or the indication information is carried in a changed system message, or the first indication information indicates, via a specific downlink signal, that the target cell will enter the energy saving state.

In other words, the terminal device may, by the first indication information carried in the paging message indicating that the target cell will enter the energy saving state, trigger the terminal device to perform the switching of the service cell or the switching of the resident cell; or, the terminal device may, by the first indication information carried in the changed system message indicating that the target cell will enter the energy saving state, trigger the terminal device to perform the switching of the service cell or the switching of the resident cell; or, the terminal device may, by the specific downlink signal indicating that the target cell will enter the energy saving state, trigger the terminal device to perform the switching of the service cell or the switching of the resident cell.

Exemplarily, the paging message may be a message transmitted by a paging device.

Herein, the paging device may be a network device or a core network device configured to provide the target cell. For example, if the terminal device is in the connected state or the inactive state, the paging device may be a network device configured to provide the target cell; if the terminal device is in the idle state, the paging device may be a core network device. The paging device may also be referred to as a paging system. The paging message transmitted by the network device configured to provide the target cell may be downlink control information (Downlink Control Information, DCI). The paging message transmitted by the core network device may be referred to as a CN paging message.

Exemplarily, the system message may be referred to as a broadcast message or system information (System Information, SI).

Exemplarily, the updated system message includes, but is not limited to: a system information block (System Information Block, SIB), a master information block (Master Information Block, MIB), or remaining system information (Remaining System Information, RMSI).

Exemplarily, if the first indication information is carried in the changed system message, a dedicated system message may be defined for the first indication information, that is, the changed system message includes the dedicated system message, and the dedicated system message is used to indicate that the target cell will enter the energy saving state. For example, the dedicated system message may be a dedicated SIB.

Exemplarily, if the first indication information is carried in the changed system message, the first indication information may be carried in the existing system message; that is, the changed system message includes the existing system message, and some fields in the existing system message carry the first indication information. For example, the existing system message may be an existing SIB.

Exemplarily, the specific downlink signal includes a channel that may be scrambled by a specific radio network temporary identifier (Radio Network Temporary Identifier, RNTI).

Exemplarily, the specific downlink signal may be a specific downlink reference signal. The downlink reference signal includes but is not limited to: a synchronization signal and/or physical broadcast channel block (Synchronization Signal/PBCH Block, SSB), a channel state information reference signal (Channel State Information Reference Signal, CSI-RS) or a downlink demodulation reference signal (Demodulation Reference Signal, DMRS). Herein, the downlink DMRS may be used for the demodulation of the downlink channel.

In some embodiments, in a case where the indication information is carried in the changed system message, the method 210 may further include:
receiving, by the terminal device, second indication information transmitted by the target cell, where the second indication information is used to indicate the terminal device to receive the changed system message.

In other words, the terminal device receives the second indication information transmitted by configured to provide the target cell.

Alternatively, the terminal device receives the second indication information transmitted by the network device by the target cell.

Exemplarily, after the terminal device receives the second indication information, the second indication information is used to indicate that a system message transmitted by the target cell has been changed; the second indication information may also be used to trigger the terminal device to receive the changed system message, and then, after the terminal device receives the changed system message, it may acquire the first indication information carried in the changed system message.

Exemplarily, the second indication information may be carried in a paging message, and the paging message may be a message transmitted by a paging device.

In other words, the paging device first transmits the second indication information to the terminal device by the paging message, and then the network device configured to provide the target cell may transmit the first indication information to the terminal device by the changed system message. Herein, the paging device may be a network device or a core network device configured to provide the target cell. For example, if the terminal device is in the connected state or the inactive state, the paging device may be a network device configured to provide the target cell; if the terminal device is in the idle state, the paging device may be a core network device. The paging device may also be referred to as a paging system. The paging message transmitted by the network device configured to provide the target cell may be downlink control information (Downlink Control Information, DCI). The paging message transmitted by the core network device may be referred to as a CN paging message.

In some embodiments, the first indication information includes at least one of:
information, used to indicate a frequency on which the terminal device preferentially resides;
duration information, used to indicate a duration between a moment when the terminal device receives the first indication information and a moment when the target cell enters the energy saving state; or
moment information, used to indicate a moment when the target cell enters the energy saving state.

Exemplarily, the information used to indicate a frequency on which the terminal device preferentially resides may be: information used to indicate a frequency point on which the terminal device preferentially resides, or information used to indicate a frequency band on which the terminal device preferentially resides, or information used to indicate a frequency level on which the terminal device preferentially resides.

Exemplarily, the duration information may be the number of time units, and the time unit may be: a frame, a subframe, a slot or a symbol.

Exemplarily, the duration information may be an absolute duration, for example, the duration information may also be a duration in seconds (s) or a duration in milliseconds (ms).

Exemplarily, when the first indication information includes the information used to indicate a frequency on which the terminal device preferentially resides, when the terminal device performs the cell reselection, the terminal device preferentially resides on the indicated frequency.

Exemplarily, if the first indication information includes the duration information, the target cell enters the energy saving state, after the duration indicated by the duration information after the moment when the terminal device receives the first indication information; if the first indication information includes the moment information, the target cell enters the energy saving state at the moment indicated by the moment information.

In some embodiments, the moment information is used to indicate a target time unit, and the moment when the target cell enters the energy saving state is a start moment or an end moment of the target time unit.

In other words, the moment information may be used to indicate that the moment when the target cell enters the energy saving state is the start moment or the end moment of the target time unit.

Exemplarily, when the target time unit is a system frame, the moment information may be a system frame number (System Frame number, SFN), to indicate that the moment when the target cell enters the energy saving state is a start position or an end position of a system frame identified by the SFN indicated by the moment information.

Exemplarily, when the target time unit is a subframe, the moment information may be an index of the subframe, to indicate that the moment when the target cell enters the energy saving state is a start position or an end position of a subframe identified by the index indicated by the moment information.

In some embodiments, a coverage-type cell in which the target cell is located is a service cell of the terminal device, or the target cell is a capacity-type cell under a service cell of the terminal device.

Exemplarily, in the network deployment, in order to meet the requirements of user mobility and throughput, the coverage-type cell and the capacity-type cell may be jointly deployed. Herein, the coverage-type cell is used to meet the coverage requirement, while the capacity-type cell is used in urban areas with a large number of users to share the traffic volume and improve the network capacity. The capacity-type cell is the target cell involved in the embodiments of the present disclosure, that is, the capacity-type cell may be in the energy saving state.

It is worth noting that the target cell involved in the present disclosure may autonomously enter the energy saving state. For example, when the traffic volume of the target cell is less than a preset threshold or there is no traffic volume, the target cell may autonomously enter the energy saving state, or the target cell may also enter the energy saving state by negotiating with a neighboring cell of the target cell, which is not limited specifically in the present disclosure.

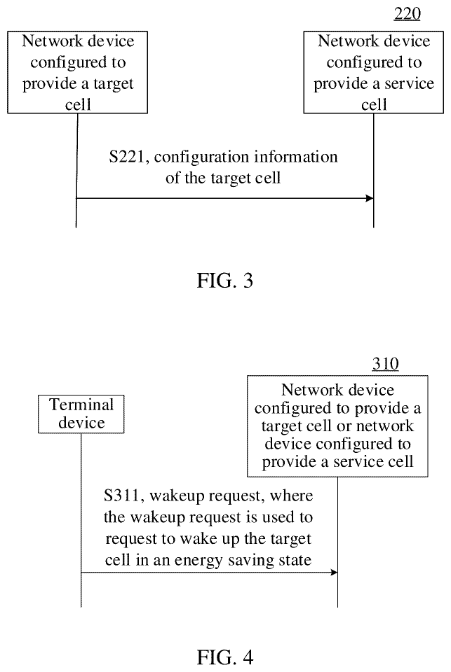

The above, in combination with FIG. 2, describes in detail the network energy saving method provided by the embodiments of the present disclosure from the perspective of the interaction between the terminal device and the target cell. The following, in combination with FIG. 3, describes the network energy saving method provided by the embodiments of the present disclosure from the perspective of the interaction between the network device configured to provide the target cell and the network device configured to provide the service cell of the terminal device.

FIG. 3 is a schematic flowchart of a network energy saving method 220 provided by the embodiments of the present disclosure. The network energy saving method 220 may be interactively performed by a network device configured to provide a service cell for a terminal device and a network device configured to provide a target cell. For example, the network device configured to provide the target cell and/or the network device configured to provide the service cell of the terminal device may be the access network device shown in FIG. 1. Of course, the network energy saving method 220 may also be understood as a method interactively performed by the service cell and the target cell, which is not limited in this disclosure. In addition, it is worth noting that in the embodiments of the present disclosure, the network device configured to provide the target cell and the network device configured to provide the service cell can be a same access network device or different access network devices, which is not limited specifically in the present disclosure.

As shown in FIG. 3, the network energy saving method 220 may include: S221, transmitting, by the target cell, configuration information of the target cell to the service cell of the terminal device. In other words, the network device configured to provide the target cell transmits the configuration information of the target cell to the network device configured to provide the service cell.

Exemplarily, the target cell is a cell that may be in an energy saving state.

It is worth noting that the term “wake up or its variants” involved in this disclosure may also be equivalently replaced by “activate or its variants”, “enable or its variants” or terms with similar meanings, the term “sleep” may also be equivalently replaced by “inactivate or its variants”, “disable or its variants” or terms with similar meanings, the term “energy saving state” may also be equivalently replaced by a “normal state,” “inactive state” “disabled state,” “non-active state” “non-enabled state” or terms with similar meanings, and the state of the target cell after being activated may also be referred to as “non-energy saving state”, “active state”, “enabled state” or terms with similar meanings, which is not specifically limited in this disclosure.

In some embodiments, the configuration information of the target cell includes at least one of:
information used to indicate a frequency point of the target cell;
information used to indicate a slice supported by the target cell;
a system message of the target cell;
information configured for a wakeup request for waking up the target cell;
a timing deviation between the service cell and the target cell; or
information used to identify whether to be close to the target cell.

In this embodiment, for the target cell that can be in the energy saving state, by transmitting the configuration information of the target cell to the service cell, it can not only ensure that the service cell knows the state of the target cell in time, thereby avoiding a case that a communication failure occurs when the service cell utilizes the target cell to share the traffic volume of the service cell because the service cell does not know the actual state of the target cell, but also improve the communication performance.

In addition, after the service cell obtains the configuration information of the target cell, the service cell may also forward the configuration information of the target cell to the terminal device under the service cell, so that the terminal device triggers a wakeup procedure of the target cell based on the configuration information of the target cell. For example, the terminal device may determine whether to trigger the wakeup procedure of the target cell based on the configuration information of the target cell, or the terminal device may determine whether to trigger the terminal device to transmit a wakeup request for waking up the target cell to the target cell or the service cell, based on the configuration information of the target cell.

Exemplarily, the information used to indicate the frequency point of the target cell may be information dedicated to indicating the frequency point, such as a new radio frequency bandwidth indicator (FreqBandlndicatorNR), or may be information used to configure a time-frequency resource, such as an absolute frequency point A (absoluteFrequencyPointA), a carrier offset (offsetToCarrier), a subcarrier spacing (subcarrierSpacing), and a location and bandwidth broadcast (locationAndBandwidthBroadcast).

Exemplarily, the system message of the target cell may be referred to as a broadcast message of the target cell or system information (System Information, SI) of the target cell.

Exemplarily, the system message of the target cell includes, but is not limited to: a system information block (System Information Block, SIB), a master information block (Master Information Block, MIB), or remaining system information (Remaining System Information, RMSI).

Exemplarily, the information configured for the wakeup request for waking up the target cell includes information used to generate the wakeup request and/or information used to configure a time-frequency resource of the wakeup request, and the information used to generate the wakeup request includes at least one of: an identifier of a ZC (Zadoff-Chu) sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

In other words, after the terminal device acquires the information used to generate the wakeup request and the information used to configure the time-frequency resource of the wakeup request, the terminal device may generate the wakeup request based on the information used to generate the wakeup request, and transmit the wakeup request to the target cell or the service cell based on the information used to configure the time-frequency resource of the wakeup request.

Exemplarily, the timing deviation may be the number of time units, and the time unit may be: a frame, a subframe, a slot or a symbol.

Exemplarily, the timing deviation may be an absolute duration, for example, the duration information may also be a duration in seconds (s) or a duration in milliseconds (ms).

Exemplarily, the information used to identify whether to be close to the target cell includes at least one of: an identifier of a beam of the service cell, an identifier of an SSB of the service cell, a threshold value corresponding to the identifier of the beam of the service cell, or a threshold value corresponding to the identifier of the SSB of the service cell.

In other words, after the terminal device acquires the information used to identify whether to be close to the target cell, the terminal device may determine whether to be close to the target cell based on the information used to identify whether to be close to the target cell, and when determining to be close to the target cell, the terminal device may trigger the wakeup procedure of the target cell. For example, when it is determined that the terminal device is close to the target cell, the terminal device transmits a wakeup request for waking up the target cell to the target cell or the service cell.

It should be understood that in the embodiments of the present disclosure, the term “beam” may also be equivalently replaced by a spatial domain filter or may correspond to a spatial domain filter. For example, a transmission beam may be called a spatial domain transmission filter or may correspond to a spatial domain transmission filter, and a reception beam may be called a spatial domain receive filter or may correspond to a spatial domain receive filter. Of course, they may also be equivalently replaced by terms with similar meanings, which are not limited specifically in this disclosure.

In some embodiments, the energy saving state means: prohibiting the target cell from performing an uplink reception or prohibiting the target cell from receiving an uplink reception except the wakeup request, and prohibiting the target cell from performing a downlink transmission.

In some embodiments, the energy saving state means: prohibiting the target cell from performing an uplink reception or prohibiting the target cell from receiving an uplink reception except the wakeup request, and prohibiting the target cell from transmitting a downlink transmission except a downlink discovery signal.

Exemplarily, the uplink reception may be a reception of an uplink channel or an uplink signal. The uplink channel may include a physical random access channel (Physical Random Access Channel, PRACH), a physical uplink control channel (Physical Uplink Control channel, PUCCH), a physical uplink shared channel (Physical Uplink Shared channel, PUSCH), or the like. The uplink signal may include an uplink demodulation reference signal (Demodulation Reference Signal, DMRS), a sounding reference signal (Sounding Reference Signal, SRS), a phase tracking reference signal (PT-RS), or the like. Herein, the uplink DMRS may be used for the demodulation of the uplink channel, the SRS may be used for the measurement of the uplink channel, the synchronization or phase tracking on the uplink time and frequency, and the PT-RS may also be used for the measurement of the uplink channel, and synchronization or phase tracking on the uplink time and frequency.

Exemplarily, the downlink transmission may be a transmission of a downlink channel or a downlink signal. The downlink channel may include a physical downlink control channel (Physical Downlink Control Channel, PDCCH), a physical downlink shared channel (Physical Downlink Shared Channel, PDSCH), a paging control channel (Paging Control Channel, PCCH), a physical broadcast channel (Physical Broadcast Channel, PBCH), a paging channel (Paging Channel, PCH), a primary common control physical channel (Primary Common Control Physical Channel, P-CCPCH), or the like. The downlink signal may include: a primary synchronization signal (Primary Synchronization Signal, PSS), a secondary synchronization signal (Secondary Synchronization Signal, SSS), a synchronization signal and/or physical broadcast channel block (Synchronization Signal/PBCH Block, SSB), a channel state information reference signal (Channel State Information Reference Signal, CSI-RS) or a downlink demodulation reference signal (Demodulation Reference Signal, DMRS), etc., where the downlink DMRS may be used for the demodulation of the downlink channel. Of course, from the perspective of the transmission of a system message, the downlink transmission may also include a transmission for system information (System Information, SI), a master information block (Master Information Block, MIB) and a system information block (System Information Block, SIB).

Exemplarily, when the target cell is in the energy saving state, the target cell may receive a wakeup request for waking up the target cell, which is transmitted by other cells or a coverage-type cell of the target cell.

Exemplarily, the target cell is prohibited from receiving signals and information from other cells, in the energy saving state.

Exemplarily, the target cell is prohibited from transmitting signals and information to other cells, in the energy saving state.

Exemplarily, the downlink discovery signal is used by the terminal device to discover the target cell.

It is worth noting that the embodiments of the present disclosure do not limit the specific type of the downlink discovery signal. For example, the downlink discovery signal may be an SSB, a CSI-RS or other downlink signals. For example, the downlink signal may also be a reference signal dedicated to discovering the target cell.

It should be understood that the embodiments of the present disclosure may include physical channels or reference signals with the same name as but different functions from those mentioned above, or may also include physical channels or reference signals with different names from but the same function as those mentioned above, which are not limited in the present disclosure. In addition, it should be understood that the terms “downlink” and “uplink” involved in the present disclosure are used to indicate the transmission direction of signals or data, where “downlink” is used to indicate that the transmission direction of signals or data is a direction from the station transmitting to the user equipment of the cell, and “uplink” is used to indicate that the transmission direction of signals or data is a direction from the user equipment of the cell transmitting to the station.

In some embodiments, a coverage-type cell in which the target cell is located is the service cell of the terminal device, or the target cell is a capacity-type cell under the service cell of the terminal device.

Exemplarily, in the network deployment, in order to meet the requirements of user mobility and throughput, the coverage-type cell and the capacity-type cell may be jointly deployed. Herein, the coverage-type cell is used to meet the coverage requirement, while the capacity-type cell is used in urban areas with a large number of users to share traffic volume and improve the network capacity. The capacity-type cell is the target cell involved in the embodiments of the present disclosure, that is, the capacity-type cell may be in the energy saving state.

The above describes in detail the network energy saving method provided by the embodiments of the present disclosure from the perspective of the target cell sleeping in combination with FIG. 2 and FIG. 3. The following will describe the cell wakeup method provided by the embodiments of the present disclosure from the perspective of the waking up of the target cell in combination with FIG. 4 to FIG. 6.

FIG. 4 is a schematic flowchart of a cell wakeup method 310 provided by the embodiments of the present disclosure. The cell wakeup method 310 may be interactively performed by a terminal device and a network device configured to provide a target cell (or a network device configured to provide a service cell for the terminal device). For example, the method may be performed interactively by the terminal device shown in FIG. 1 and the access network device shown in FIG. 1. Of course, the cell wakeup method 310 may also be understood as a method interactively performed by the terminal device and the target cell (or the service cell), which is not limited in this disclosure.

As shown in FIG. 4, the cell wakeup method 310 may include: S311, transmitting a wakeup request, where the wakeup request is used to request to wake up a target cell in an energy saving state.

In the embodiments of the present disclosure, waking up the target cell by the terminal device transmitting the wakeup request, can wake up the target cell in real time by the triggering of the terminal device, on the basis of reducing the energy consumption of the network device configured to provide the target cell, thereby improving the flexibility of the target cell.

It is worth noting that the term “wake up or its variants” involved in this disclosure may also be equivalently replaced by “activate or its variants”, “enable or its variants” or terms with similar meanings, the term “sleep” may also be equivalently replaced by “inactivate or its variants”, “disable or its variants” or terms with similar meanings, the term “energy saving state” may also be equivalently replaced by a “normal state,” “inactive state” “disabled state,” “non-active state” “non-enabled state” or terms with similar meanings, and the state of the target cell after being activated may also be referred to as “non-energy saving state”, “active state”, “enabled state” or terms with similar meanings, which is not specifically limited in this disclosure.

In some embodiments, the energy saving state means: prohibiting the target cell from performing an uplink reception or prohibiting the target cell from receiving an uplink reception except a wakeup request for waking up the target cell, and prohibiting the target cell from performing a downlink transmission.

In some embodiments, the energy saving state means: the energy saving state means: prohibiting the target cell from performing an uplink reception or prohibiting the target cell from receiving an uplink reception except a wakeup request for waking up the target cell, and prohibiting the target cell from transmitting a downlink transmission except a downlink discovery signal.

Exemplarily, the uplink reception may be a reception of an uplink channel or an uplink signal. The uplink channel may include a physical random access channel (Physical Random Access Channel, PRACH), a physical uplink control channel (Physical Uplink Control channel, PUCCH), a physical uplink shared channel (Physical Uplink Shared channel, PUSCH), or the like.

The uplink signal may include an uplink demodulation reference signal (Demodulation Reference Signal, DMRS), a sounding reference signal (Sounding Reference Signal, SRS), a phase tracking reference signal (PT-RS), or the like. Herein, the uplink DMRS may be used for the demodulation of the uplink channel, the SRS may be used for the measurement of the uplink channel, the synchronization or phase tracking on the uplink time and frequency, and the PT-RS may also be used for the measurement of the uplink channel, and synchronization or phase tracking on the uplink time and frequency.

Exemplarily, the downlink transmission may be a transmission of a downlink channel or a downlink signal. The downlink channel may include a physical downlink control channel (Physical Downlink Control Channel, PDCCH), a physical downlink shared channel (Physical Downlink Shared Channel, PDSCH), a paging control channel (Paging Control Channel, PCCH), a physical broadcast channel (Physical Broadcast Channel, PBCH), a paging channel (Paging Channel, PCH), a primary common control physical channel (Primary Common Control Physical Channel, P-CCPCH), or the like. The downlink signal may include: a primary synchronization signal (Primary Synchronization Signal, PSS), a secondary synchronization signal (Secondary Synchronization Signal, SSS), a synchronization signal and/or physical broadcast channel block (Synchronization Signal/PBCH Block, SSB), a channel state information reference signal (Channel State Information Reference Signal, CSI-RS) or a downlink demodulation reference signal (Demodulation Reference Signal, DMRS), etc., where the downlink DMRS may be used for the demodulation of the downlink channel. Of course, from the perspective of the transmission of a system message, the downlink transmission may also include a transmission for system information (System Information, SI), a master information block (Master Information Block, MIB) and a system information block (System Information Block, SIB).

Exemplarily, when the target cell is in the energy saving state, the target cell may receive a wakeup request for waking up the target cell, which is transmitted by other cells or a coverage-type cell of the target cell.

Exemplarily, the target cell is prohibited from receiving signals and information from other cells, in the energy saving state.

Exemplarily, the target cell is prohibited from transmitting signals and information to other cells, in the energy saving state.

Exemplarily, the downlink discovery signal is used by the terminal device to discover the target cell.

It is worth noting that the embodiments of the present disclosure do not limit the specific type of the downlink discovery signal. For example, the downlink discovery signal may be an SSB, a CSI-RS or other downlink signals. For example, the downlink discovery signal may also be a reference signal dedicated to discovering the target cell.

It should be understood that the embodiments of the present disclosure may include physical channels or reference signals with the same name as but different functions from those mentioned above, or may also include physical channels or reference signals with different names from but the same function as those mentioned above, which are not limited in the present disclosure. In addition, it should be understood that the terms “downlink” and “uplink” involved in the present disclosure are used to indicate the transmission direction of signals or data, where “downlink” is used to indicate that the transmission direction of signals or data is a direction from the station transmitting to the user equipment of the cell, and “uplink” is used to indicate that the transmission direction of signals or data is a direction from the user equipment of the cell transmitting to the station.

In some embodiments, the S311 may include:
transmitting, by the terminal device, the wakeup request to the target cell.

In other words, the terminal device transmits the wakeup request to the network device configured to provide the target cell.

Alternatively, the terminal device transmits the wakeup request to the network device by the target cell.

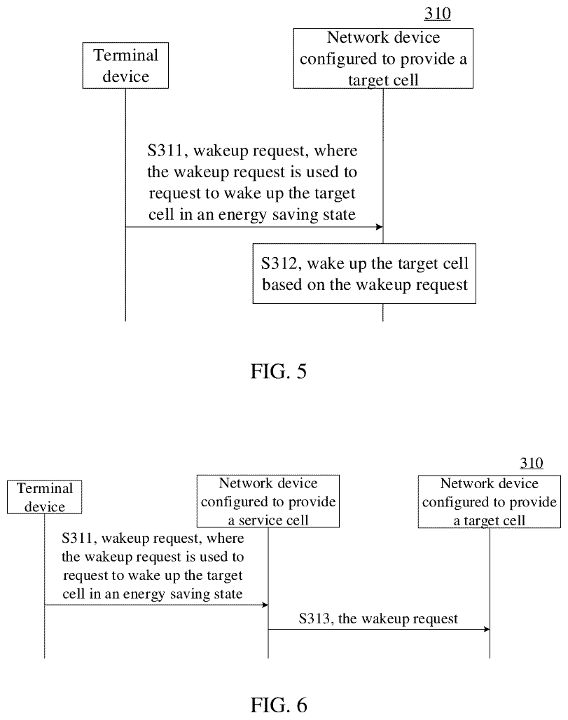

Exemplarily, as shown in FIG. 5, the method 310 may further include:
S312, waking up, by the network device configured to provide the target cell, the target cell based on the wakeup request.

Exemplarily, the network device configured to provide the target cell may directly wake up the target cell after receiving the wakeup request.

In some embodiments, the method 310 may further include:
determining whether to wake up the target cell.

Exemplarily, the network device configured to provide the target cell determines whether to wake up the target cell after receiving the wakeup request, and wakes up the target cell when determining to wake up the target cell.

In some embodiments, the network device configured to provide the target cell may determine whether to wake up the target cell based on at least one of:
a deployment location of the target cell, a moment when the wakeup request is received, and a time period of a moment when the wakeup request is received.

It is worth noting that in the mobile communication network, the distribution of traffics varies with time. For example, there will be less traffics at night, more traffics during the day, and even less traffics at midnight. At the same time, the distribution of traffics is also related to the geographical area. For example, during the day, locations with a lot of office buildings have a higher volume of users, but have almost no user at night. However, in urban or residential areas, the traffic volume is very small during the daytime working time periods, but the traffic volume may be larger at night. In view of this, in the embodiments of the present disclosure, whether to sleep or wake up the target cell may be determined by the amount of the traffic volume. Furthermore, since when the target cell is in the energy saving state, the target cell does not know whether the current traffic volume is large or small, and factors such as the deployment location of the target cell, the moment when the wakeup request is received, and the time period of the moment when the wakeup request is received, etc., can reflect the traffic volume of the service cell, therefore, by determining whether to wake up the target cell by considering factors such as the deployment location of the target cell, the moment when the wakeup request is received, and the time period of the moment when the wakeup request is received, etc., it can be implemented that the network deployment of the target cell can dynamically adjust its state, such as dynamically wake up or sleep the target cell or determine whether to wake up the target cell, according to the change in the traffic volume, which can achieve the purpose of network energy saving.

In some embodiments, the wakeup request requests to wake up the target cell by a ZC sequence or a preamble code.

Exemplarily, the ZC sequence used by the wakeup request may be any ZC sequence available for the target cell.

Exemplarily, the ZC sequence used by the wakeup request may be a ZC sequence reserved for the wakeup request among ZC sequences available for the target cell. Herein, the ZC sequence reserved for the wakeup request may be one or more ZC sequences.

Exemplarily, the preamble code used by the wakeup request may be any preamble code available for the target cell.

Exemplarily, the preamble code used by the wakeup request may be a preamble code reserved for the wakeup request among the preamble codes available for the target cell. Herein, the preamble code reserved for the wakeup request may be one or more preamble codes.

Exemplarily, the terminal device transmits the ZC sequence or the preamble code to the target cell, and the ZC sequence or the preamble code is used to request to wake up the target cell. In other words, the ZC sequence or the preamble code is used to trigger the network device configured to provide the target cell to wake up the target cell.

In some embodiments, the ZC sequence used by the wakeup request is different from a ZC sequence used by the target cell, or a root sequence used to generate the ZC sequence used by the wakeup request is different from a root sequence used by a neighboring cell of the target cell.

In this embodiment, by distinguishing the ZC sequence used by the wakeup request from the ZC sequence used by the target cell, or by distinguishing the root sequence of the ZC sequence used by the wakeup request from the root sequence of the ZC sequence used by the target cell, it can be ensured that the cell (i.e., the target cell) using the ZC sequence used by the wakeup request or the root sequence of the ZC sequence used by the wakeup request knows that the wakeup request is a request transmitted by the terminal device to itself, so that the terminal device's transmitting of the wakeup request is consistent with the target cell's reception of the wakeup request, thereby improving the wakeup success rate.

In some embodiments, the method 310 may further include:
transmitting, by the network device configured to provide the target cell, notification information to a neighboring cell of the target cell, where the notification information is used to indicate that the target cell has been woken up.

In this embodiment, the network device configured to provide the target cell transmits the notification information to the neighboring cell of the target cell, which can ensure that the neighboring cell of the target cell can know the state of the target cell in time, thereby avoiding a case that a communication failure occurs when the target cell is utilized to share the traffic volume of the service cell, and improving the communication performance.

In some embodiments, the method 310 may further include:
transmitting, by the network device configured to provide the target cell, a downlink discovery signal.

Exemplarily, after the target cell enters the energy saving state, the target cell transmits a downlink discovery signal to the terminal device. For example, the target cell periodically transmits the downlink discovery signal after entering the energy saving state. Correspondingly, when the terminal device is located within the coverage range of the target cell, the terminal device may discover the target cell by the downlink discovery signal.

Exemplarily, if the energy saving state indicates prohibiting the target cell from transmitting a downlink transmission except the downlink discovery signal, the target cell transmits the downlink discovery signal to the terminal device.

In some embodiments, the terminal device is in a connected state, and S310 may include: transmitting the wakeup request to a service cell of the terminal device.

In other words, the terminal device transmits the wakeup request to the network device configured to provide the service cell.

Alternatively, the terminal device transmits the wakeup request to the network device by the service cell.

Exemplarily, as shown in FIG. 6, the method 310 may further include:
S313, forwarding, by the network device configured to provide the service cell, the wakeup request to the network device configured to provide the target cell.

In other words, after receiving the wakeup request transmitted by the terminal device, the network device configured to provide the service cell forwards the wakeup request to the network device configured to provide the target cell.

Exemplarily, after receiving the wakeup request, the network device configured to provide the service cell may directly forward the wakeup request to the network device configured to provide the target cell, so that the network device configured to provide the target cell wakes up the target cell.

In some embodiments, the method 310 may further include:
determining, by the network device configured to provide the service cell, whether to forward the wakeup request to the network device configured to provide the target cell.

Exemplarily, after receiving the wakeup request, the network device configured to provide the service cell determines whether to forward the wakeup request to the network device configured to provide the target cell, and when determining to forward the wakeup request, forwards the wakeup request to the network device configured to provide the target cell.

In some embodiments, the network device configured to provide the service cell determines whether to forward the wakeup request to the target cell based on at least one of:
traffic volume of the service cell, a deployment location of the service cell, a deployment location of the target cell, a moment when the wakeup request is received, and a time period of a moment when the wakeup request is received.

It is worth noting that in the mobile communication network, the distribution of traffics varies with time. For example, there will be less traffics at night, more traffics during the day, and even less traffics at midnight. At the same time, the distribution of traffics is also related to the geographical area. For example, during the day, locations with a lot of office buildings have a higher volume of users, but have almost no user at night. However, in urban or residential areas, the traffic volume is very small during the daytime working time periods, but the traffic volume may be larger at night. In view of this, in the embodiments of the present disclosure, the network device configured to provide the service cell may determine whether to sleep or wake up the target cell by the amount of the traffic volume. Since factors such as the deployment location of the target cell, the moment when the wakeup request is received, and the time period of the moment when the wakeup request is received, etc., can reflect the traffic volume of the service cell, by determining whether to forward the wakeup request to the target cell by considering factors such as the deployment location of the target cell, the moment when the wakeup request is received, and the time period of the moment when the wakeup request is received, etc., it can be implemented that the network deployment of the target cell can dynamically adjust its state, such as dynamically wake up or sleep the target cell or determine whether to wake up the target cell, according to the change in the traffic volume, which can achieve the purpose of network energy saving.

Of course, since the service cell can obtain the traffic volume of the service cell, in other alternative embodiments, the service cell may also determine whether to forward the wakeup request to the target cell based on the traffic volume of the service cell, which is not limited specifically in this disclosure.

In some embodiments, the wakeup request carries identifier information of the target cell.

Exemplarily, the identifier information is used by the network device configured to provide the service cell to determine or identify the network device configured to provide the target cell.

In some embodiments, the identifier information includes at least one of: a physical cell identifier (Physical Cell Identifier, PCI) of the target cell, a frequency point of the target cell, and a cell identifier of the target cell.

Exemplarily, the identifier information includes the PCI of the target cell and the frequency point of the target cell.

Exemplarily, the identifier information includes the cell identifier of the target cell.

Exemplarily, the cell identifier of the target cell is used to uniquely identify the target cell.

Exemplarily, the PCI of the target cell is used to distinguish or identify a wireless signal of the target cell. For example, the PCI used by other cells within the coverage range of the target cell is different from the PCI used by the target cell.

In some embodiments, the method 310 may further include:
receiving, by the network device configured to provide the service cell, notification information transmitted by the target cell, where the notification information is used to indicate that the target cell has been woken up.

In this embodiment, the network device configured to provide the service cell receives the notification information transmitted by the target cell, which can ensure that the service cell can know the state of the target cell in time, and thereby avoiding a case that a communication failure occurs when the target cell is utilized to share the traffic volume of the service cell, and improving the communication performance.

In some embodiments, the S310 may include:
transmitting the wakeup request, when the terminal device is close to the target cell and the terminal device expects to wake up the target cell.

Exemplarily, the terminal device being close to the target cell means that the terminal device is located within the coverage range of the target cell.

Exemplarily, the terminal device being close to the target cell means that the terminal device is close to the coverage range of the target cell, for example, the terminal device is close to the edge location of the coverage range of the target cell.

Exemplarily, the terminal device expecting to wake up the target cell means that: after the target cell is woken up, the terminal device expects to utilize the target cell for the data transmission and/or data reception.

In some embodiments, the method 310 may further include:
determining that the terminal device is close to the target cell, when beam quality of a service cell of the terminal device is greater than or equal to a first threshold value, and/or, when signal quality of a synchronization signal and/or physical broadcast channel block (Synchronization Signal/PBCH Block, SSB) of the service cell is greater than or equal to a second threshold value,
Exemplarily, the target cell is a cell in the direction of the beam used by the service cell.

Exemplarily, the target cell is a cell in the direction of the SSB used by the service cell.

Exemplarily, the first threshold value may be configured by the service cell, or may be also determined by the terminal device, or may also be predefined, or may even be determined by the negotiation between the service cell and the terminal device. Similarly, the second threshold value may be configured by the service cell, or may also be determined by the terminal device, or may also be predefined, or may even be determined by the negotiation between the service cell and the terminal device.

Exemplarily, the beam quality includes but is not limited to: reference signal receiving power (Reference Signal Receiving Power, RSRP) or reference signal receiving quality (Reference Signal Receiving Quality, RSRQ).

Exemplarily, the signal quality of the SSB of the service cell includes but is not limited to: RSRP or RSRQ.

In this embodiment, if the beam quality of the service cell of the terminal device is greater than or equal to the first threshold value, it means that the terminal device is in the direction of the beam of the service cell. If the signal quality of the SSB of the service cell is greater than or equal to the second threshold value, it means that the terminal device is in the direction of the SSB used by the service cell. At this time, directly determining that the terminal device is close to the target cell, may not only realize the determination of whether the terminal device is close to the target cell, but also reduce the complexity thereof, thereby improving the performance of the terminal device.

Of course, in other alternative embodiments, when the beam quality of the service cell of the terminal device is within a beam quality range, and/or when the signal quality of the SSB of the service cell is within a signal quality range, it may also be determined that the terminal device is close to the target cell, and even the terminal device may use other methods to determine whether the terminal device is close to the target cell, which is not limited specifically in the present disclosure.

For example, the terminal device may determine whether to be close to the target cell based on a distance of the terminal device relative to the network device configured to provide the target cell. In one implementation, if the distance of the terminal device relative to the network device configured to provide the target cell is less than a preset threshold, it is determined that the terminal device is close to the target cell; otherwise, it is determined that the terminal device is not close to the target cell; in another implementation, if the distance of the terminal device relative to the network device configured to provide the target cell is within a preset range, it is determined that the terminal device is close to the target cell; otherwise, it is determined that the terminal device is not close to the target cell. Optionally, the preset threshold or the preset range may be determined based on a radius of a coverage range of the target cell. Optionally, the distance of the terminal device relative to the network device configured to provide the target cell may be determined, based on a location of the network device configured to provide the target cell relative to the network device configured to provide the target cell, and a location of the terminal device relative to the network device configured to provide the service cell.

For another example, in the direction of the beam used when the service cell transmits information to the target cell, the terminal device may determine whether to be close to the target cell based on the distance of the terminal device relative to the network device configured to provide the service cell. In one implementation, if the distance of the terminal device relative to the network device configured to provide the service cell is greater than a preset threshold, it is determined that the terminal device is close to the target cell; otherwise, it is determined that the terminal device is not close to the target cell; in another implementation, if the distance of the terminal device relative to the network device configured to provide the service cell is within a preset range, it is determined that the terminal device is close to the target cell; otherwise, it is determined that the terminal device is not close to the target cell. Optionally, the preset threshold or the preset range may be determined according to the coverage range of the service cell, the coverage range of the target cell, and a location of the service cell relative to the target cell.

In some embodiments, the method 310 may further include:
determining that the terminal device expects to wake up the target cell, when a priority of a frequency of the target cell is greater than a priority of a frequency of a service cell of the terminal device, and/or when a slice supported by the target cell is a slice expected by the terminal device.

Exemplarily, when the priority of the frequency point (frequency band or frequency level) of the target cell is greater than the priority of the frequency point (frequency band or frequency level) of the service cell, it is determined that the terminal device expects to wake up the target cell. In other words, if the terminal device expects to perform the data transmission and/or data reception on the frequency point (frequency band or frequency level) of the target cell, it is determined that the terminal device expects to wake up the target cell.

Exemplarily, if the terminal device expects to perform the data transmission and/or data reception on the slice supported by the target cell, it is determined that the terminal device expects to wake up the target cell. In other words, when the priority of the slices supported by the target cell is greater than the priority of the slice supported by the service cell, it is determined that the terminal device expects to wake up the target cell.

In some embodiments, the S310 may include:
receiving, by the terminal device, a downlink discovery signal transmitted by the target cell;
transmitting the wakeup request, when the terminal device is close to the target cell, quality of the downlink discovery signal meets a wakeup requirement, and the target cell and the terminal device expect to wake up the target cell.

Exemplarily, the quality of the downlink discovery signal meeting the wakeup requirement means that the quality of the downlink discovery signal meets the quality requirement of the terminal device performing the data transmission and/or data reception by utilizing the target cell.

In some embodiments, the method 310 may further include:
determining, by the terminal device, that the quality of the downlink discovery signal meets the wakeup requirement, when the quality of the downlink discovery signal is greater than or equal to a third threshold value.

Exemplarily, the third threshold value may be configured by the service cell, or may also be determined by the terminal device, or may also be predefined, or may even be determined by the negotiation between the service cell and the terminal device.

Exemplarily, the third threshold value may be a threshold value involved in the cell selection or cell reselection.

Exemplarily, the quality of the downlink discovery signal includes but is not limited to: RSRP or RSRQ.

Of course, in other alternative embodiments, the quality of the downlink discovery signal meeting the wakeup requirement may also mean that the quality of the downlink reference signal is within a certain quality range, which is not specifically limited in the present disclosure.

It is worth noting that if the terminal device transmits the wakeup request when the terminal device is close to the target cell and the terminal device expects to wake up the target cell, the energy saving state involved in the present disclosure may mean prohibiting the target cell from performing a downlink transmission, or prohibiting the target cell from transmitting a downlink transmission except the downlink discovery signal; if the terminal device transmits the wakeup request when the terminal device is close to the target cell, quality of the downlink discovery signal meets a wakeup requirement, and the target cell and the terminal device expect to wake up the target cell, the energy saving state involved in the present disclosure means prohibiting the target cell from transmitting a downlink transmission except the downlink discovery signal.

In some embodiments, the method 310 may further include:
performing, by the terminal device, a cell selection operation and/or a cell reselection operation at an interval of a first duration after transmitting the wakeup request.

Exemplarily, the first duration may include a transmission duration of the wakeup request and/or a wakeup duration when the network device configured to provide the target cell wakes up the target cell. Optionally, when the terminal device transmits the wakeup request to the target cell by the service cell, the transmission duration includes a duration occupied when the wakeup request is transmitted between the terminal device and the service cell, and a duration occupied when the wakeup request is transmitted between the service cell and the target cell, and the transmission duration may even include a forwarding duration when the service cell forwards the wakeup request.

In some embodiments, after transmitting the wakeup request, the terminal device starts a timer with a duration of the first duration; if the timer times out, the cell selection operation and/or the cell reselection operation is performed.

Exemplarily, the terminal device starts the timer with a duration of the first duration at the end moment of transmitting the wakeup request; if the timer times out, the cell selection operation and/or the cell reselection operation is performed. Of course, in other alternative embodiments, the terminal device may also start the timer with a duration of the first duration at the start moment of transmitting the wakeup request; if the timer times out, the cell selection operation and/or the cell reselection operation is performed. At this time, the first duration may also include a duration occupied when the terminal device transmits the wakeup request, in addition to the transmission duration of the wakeup request and/or the wakeup duration when the network device configured to provide the target cell wakes up the target cell.

In some embodiments, the first duration is determined by the terminal device, or the first duration is a duration configured by the network device, or the first duration is a predefined duration, or the first duration depends on an implementation of the terminal device.

Exemplarily, the first duration may be configured by transmitting a timer parameter to the terminal device.

Exemplarily, the first duration is a duration configured by the network device, or may be a duration configured by the service cell, or a duration configured by the target cell and forwarded by the service cell to the terminal device.

In some embodiments, after transmitting the wakeup request, the terminal device receives a synchronization signal and a system message transmitted by the target cell, at the interval of the first duration after transmitting the wakeup request; and performs the cell selection operation and/or the cell reselection operation based on the synchronization signal and the system message.

Exemplarily, the synchronization signal includes but is not limited to: a primary synchronization signal (Primary Synchronization Signal, PSS) and a secondary synchronization signal (Secondary Synchronization Signal, SSS).

Exemplarily, the system message includes but is not limited to: system information (System Information, SI), a master information block (Master Information Block, MIB), a system information block (System Information Block, SIB), and remaining system information (Remaining System Information, RMSI).

Exemplarily, after transmitting the wakeup request, the terminal device starts a timer with a duration of the first duration; if the timer times out, receives the synchronization signal and the system message transmitted by the target cell; and based on the synchronization signal and the system message, performs the cell selection operation and/or the cell reselection operation.

Of course, in other alternative embodiments, if there is a paging message of the terminal device, the terminal device may further receive the paging message after transmitting the wakeup request. For example, the paging message, the synchronization signal and the system message transmitted by the target cell are received simultaneously at the interval of the first duration after transmitting the wakeup request. In addition, the terminal device may also start to receive the synchronization signal and the system message directly after transmitting the wakeup request, and start the timer with a duration of the first duration after transmitting the wakeup request. In this case, if the timer times out, the cell selection operation and/or the cell reselection operation is performed. That is, the timer with a duration of the first duration may be used only to trigger the cell selection operation and/or the cell reselection operation, or may be also used to trigger the cell selection operation and/or the cell reselection operation on the basis of triggering the terminal device to receive the synchronization signal and the system message.

In some embodiments, the method 310 may further include:
receiving, by the terminal device, configuration information of the target cell transmitted by a service cell of the terminal device, where the configuration information of the target cell includes at least one of:
information used to indicate a frequency point of the target cell;
information used to indicate a slice supported by the target cell;
a system message of the target cell;
configuration information of the wakeup request;
a timing deviation between the service cell and the target cell; or configuration information used to identify whether to be close to the target cell.

Exemplarily, the configuration information of the target cell is configuration information transmitted by the target cell to the service cell when the target cell enters the energy saving state.

In this embodiment, for the target cell that can be in the energy saving state, transmitting the configuration information of the target cell by the service cell is beneficial for the terminal device to determine whether to trigger the wakeup procedure of the target cell, or beneficial for the terminal device to determine whether to trigger the terminal device to transmit the wakeup request for waking up the target cell to the target cell or the service cell. For example, the information used to indicate the frequency point of the target cell and the information used to indicate the slice supported by the target cell in the configuration information of the target cell may be used by the terminal device to determine whether to expect to activate the target cell; the configuration information used to identify whether to be close to the target cell in the configuration information of the target cell may be used by the terminal device to determine whether the terminal device is close to the target cell; the configuration information of the wakeup request in the configuration information of the target cell may be used by the terminal device to transmit the wakeup request.

Exemplarily, the information used to indicate the frequency point of the target cell may be information dedicated to indicating the frequency point, such as a new radio frequency bandwidth indicator (FreqBandlndicatorNR), or may be information used to configure a time-frequency resource, such as an absolute frequency point A (absoluteFrequencyPointA), a carrier offset (offsetToCarrier), a subcarrier spacing (subcarrierSpacing), and a location and bandwidth broadcast (locationAndBandwidthBroadcast).

Exemplarily, the system message of the target cell may be referred to as a broadcast message of the target cell or system information (System Information, SI) of the target cell.

Exemplarily, the system message of the target cell includes, but is not limited to: a system information block (System Information Block, SIB), a master information block (Master Information Block, MIB), or remaining system information (Remaining System Information, RMSI).

Exemplarily, the configuration information of the wakeup request includes information used to generate the wakeup request and/or information used to configure a time-frequency resource of the wakeup request, and the information used to generate the wakeup request includes at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

In other words, after the terminal device acquires the information used to generate the wakeup request and the information used to configure the time-frequency resource of the wakeup request, the terminal device may generate the wakeup request based on the information used to generate the wakeup request, and transmit the wakeup request to the target cell or the service cell based on the information used to configure the time-frequency resource of the wakeup request.

Exemplarily, the timing deviation may be the number of time units, and the time unit may be: a frame, a subframe, a slot or a symbol.

Exemplarily, the timing deviation may be an absolute duration, for example, the duration information may also be a duration in seconds (s) or a duration in milliseconds (ms).

Exemplarily, the information used to identify whether to be close to the target cell includes at least one of: an identifier of a beam of the service cell, an identifier of an SSB of the service cell, a threshold value corresponding to the identifier of the beam of the service cell, or a threshold value corresponding to the identifier of the SSB of the service cell.

In other words, after the terminal device acquires the information used to identify whether to be close to the target cell, the terminal device may determine whether to be close to the target cell based on the information used to identify whether to be close to the target cell, and when determining to be close to the target cell, the terminal device may trigger the wakeup procedure of the target cell. For example, when the terminal device determines to be close to the target cell, the terminal device transmits a wakeup request for waking up the target cell to the target cell or the service cell.

Exemplarily, the threshold value corresponding to the identifier of the beam of the service cell may be the first threshold value mentioned above.

Exemplarily, the threshold value corresponding to the identifier of the SSB of the service cell may be the second threshold value mentioned above.

Of course, in other alternative embodiments, the configuration information of the target cell may also include information used to determine that the quality of the downlink discovery signal meets the wakeup requirement. For example, the information used to determine that the quality of the downlink discovery signal meets the wakeup requirement may be the third threshold value mentioned above.

In some embodiments, a coverage-type cell in which the target cell is located is a service cell of the terminal device, or the target cell is a capacity-type cell under a service cell of the terminal device.

Exemplarily, in the network deployment, in order to meet the requirements of user mobility and throughput, the coverage-type cell and the capacity-type cell may be jointly deployed. Herein, the coverage-type cell is used to meet the coverage requirement, while the capacity-type cell is used in urban areas with a large number of users to share traffic volume and improve the network capacity. The capacity-type cell is the target cell involved in the embodiments of the present disclosure, that is, the capacity-type cell may be in the energy saving state.

The cell wakeup method is exemplarily described below in conjunction with the specific embodiments provided by this disclosure.

### Embodiment 1

In this embodiment, when the target cell is in the energy saving state, the target cell is prohibited from performing an uplink reception or is prohibited from receiving an uplink reception except the wakeup request used to wake up the target cell, and the target cell is prohibited from performing a downlink transmission. In this case, the terminal device wakes up the target cell by transmitting the wakeup request to the target cell.

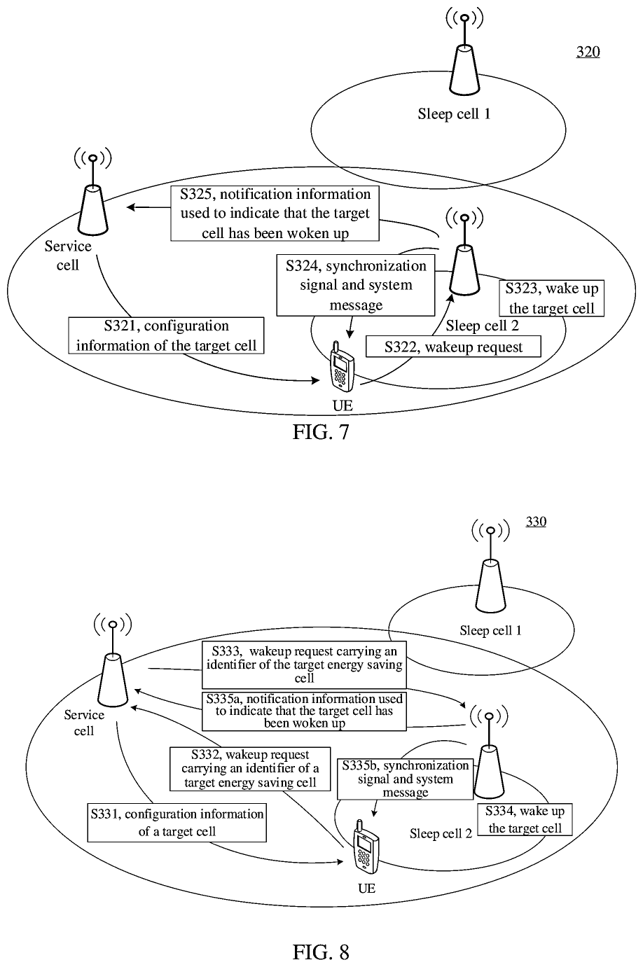

FIG. 7 is a schematic flowchart of a method 320 for waking up a target cell by transmitting a wakeup request to the target cell in a case of the absence of a downlink discovery signal, provided by the embodiments of the present disclosure.

As shown in FIG. 7, it is assumed that sleep cells that intersect with the coverage range of the service cell of the terminal device include a sleep cell 1 and a sleep cell 2. The following describes a method for waking up the dormant cell 2 by taking the dormant cell 2 as the target cell. The method 320 may include:
S321, the service cell of the terminal device transmits configuration information of the target cell to the terminal device.

Exemplarily, the configuration information of the target cell includes at least one of: information used to indicate a frequency point of the target cell;
information used to indicate a slice supported by the target cell;
a system message of the target cell;
configuration information of the wakeup request;
a timing deviation between the service cell and the target cell; or
configuration information used to identify whether to be close to the target cell.

It should be understood that the descriptions of various information in the configuration information of the target cell may refer to the relevant descriptions above, which will not be repeated herein to avoid a repetition.

S322, the terminal device transmits a wakeup request to the target cell, where the wakeup request is used to request to wake up the target cell.

Exemplarily, the wakeup request requests to wake up the target cell by a ZC sequence or a preamble code.

Exemplarily, the ZC sequence used by the wakeup request is different from a ZC sequence used by the target cell, or a root sequence used to generate the ZC sequence used by the wakeup request is different from a root sequence used by a neighboring cell of the target cell.

Exemplarily, when the terminal device is close to the target cell and the terminal device expects to wake up the target cell, the terminal device transmits the wakeup request to the target cell. Optionally, when beam quality of the service cell of the terminal device is greater than or equal to a first threshold value, and/or when signal quality of a synchronization signal and/or physical broadcast channel block (Synchronization Signal/PBCH Block, SSB) of the service cell is greater than or equal to a second threshold value, the terminal device determines that the terminal device is close to the target cell. When the priority of the frequency of the target cell is greater than the priority of the frequency of the service cell of the terminal device, and/or when the slice supported by the target cell is a slice expected by the terminal device, the terminal device determines that the terminal device expects to wake up the target cell.

Exemplarily, the configuration information of the wakeup request in the configuration information of the target cell includes information used to generate the wakeup request and/or information used to configure a time-frequency resource of the wakeup request, and the information used to generate the wakeup request includes at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

Exemplarily, configuration information used to identify whether to be close to the target cell, in the configuration information of the target cell may include: the first threshold value and the second threshold value.

S323, the target cell, after receiving the wakeup request from the terminal device, wakes up the target cell, that is, the target cell resumes to a normal cell state or a non-energy saving state.

Exemplarily, the target cell, after receiving the wakeup request, may directly wake up the target cell.

Exemplarily, the target cell, after receiving the wakeup request, determines whether to wake up the target cell, and wakes up the target cell when determining to wake up the target cell.

Exemplarily, the target cell may determine whether to wake up the target cell based on at least one of:
a deployment location of the target cell, a moment when the wakeup request is received, and a time period of a moment when the wakeup request is received.

It is worth noting that in the mobile communication network, the distribution of traffics varies with time. For example, there will be less traffics at night, more traffics during the day, and even less traffics at midnight. At the same time, the distribution of traffics is also related to the geographical area. For example, during the day, locations with a lot of office buildings have a higher volume of users, but have almost no user at night. However, in urban or residential areas, the traffic volume is very small during the daytime working time periods, but the traffic volume may be larger at night. In view of this, in the embodiments of the present disclosure, whether to sleep or wake up the target cell may be determined by the amount of the traffic volume. Furthermore, since when the target cell is in the energy saving state, the target cell does not know whether the current traffic volume is large or small, and factors such as the deployment location of the target cell, the moment when the wakeup request is received, and the time period of the moment when the wakeup request is received, etc., can reflect the traffic volume of the service cell, therefore, by determining whether to wake up the target cell by considering factors such as the deployment location of the target cell, the moment when the wakeup request is received, and the time period of the moment when the wakeup request is received, etc., it can be implemented that the network deployment of the target cell can dynamically adjust its state, such as dynamically wake up or sleep the target cell or determine whether to wake up the target cell, according to the change in the traffic volume, which can achieve the purpose of network energy saving.

S324, the target cell transmits a synchronization signal and a system message, etc., to the terminal device.

Exemplarily, the synchronization signal includes but is not limited to: a primary synchronization signal (Primary Synchronization Signal, PSS) and a secondary synchronization signal (Secondary Synchronization Signal, SSS).

Exemplarily, the system message includes but is not limited to: system information (System Information, SI), a master information block (Master Information Block, MIB), a system information block (System Information Block, SIB), and remaining system information (Remaining System Information, RMSI).

Exemplarily, after transmitting the wakeup request, the terminal device starts a timer with a duration of the first duration; if the timer times out, receives the synchronization signal and the system message transmitted by the target cell; and based on the synchronization signal and the system message, performs the cell selection operation and/or the cell reselection operation.

Of course, in other alternative embodiments, if there is a paging message of the terminal device, the terminal device may further receive the paging message after transmitting the wakeup request. For example, the paging message, the synchronization signal and the system message transmitted by the target cell are received simultaneously at the interval of the first duration after transmitting the wakeup request. In addition, the terminal device may also start to receive the synchronization signal and the system message directly after transmitting the wakeup request, and start the timer with a duration of the first duration after transmitting the wakeup request. In this case, if the timer times out, the cell selection operation and/or the cell reselection operation is performed. That is, the timer with a duration of the first duration may be used only to trigger the cell selection operation and/or the cell reselection operation, or may be also used to trigger the cell selection operation and/or the cell reselection operation on the basis of triggering the terminal device to receive the synchronization signal and the system message.

S325, the target cell transmits notification information to the service cell to indicate that the target cell has been woken up.

In this embodiment, the target cell is woken up by transmitting the wakeup request to the target cell by the terminal device, which can wake up the target cell in real time by the triggering of the terminal device on the basis of reducing the energy consumption of the target cell, thereby improving the flexibility of the target cell. In addition, after the target cell is woken up, the target cell transmits the notification information to the service cell, which can ensure that the service cell can know the state of the target cell in time, thereby avoiding a case where a communication failure occurs when the target cell is utilized to share the traffic volume of the service cell, and improving the communication performance.

### Embodiment 2

In this embodiment, when the target cell is in the energy saving state, the target cell is prohibited from performing an uplink reception or is prohibited from receiving an uplink reception except the wakeup request used to wake up the target cell, and the target cell is prohibited from performing a downlink transmission. In this case, if the RRC connected state of the terminal device is the active state, the terminal device may wake up the target cell by transmitting a wakeup request to the target cell via the service cell of the terminal device.

FIG. 8 is a schematic flowchart of a method 330 for waking up a target cell by transmitting a wakeup request to the service cell in a case of the absence of a downlink discovery signal, provided by the embodiments of the present disclosure.

As shown in FIG. 8, it is assumed that sleep cells that intersect with the coverage range of the service cell of the terminal device include a sleep cell 1 and a sleep cell 2. The following describes a method for waking up the dormant cell 2 by taking the dormant cell 2 as the target cell.

The method 330 may include: S331, the service cell of the terminal device transmits configuration information of the target cell to the terminal device.

Exemplarily, the configuration information of the target cell includes at least one of: information used to indicate a frequency point of the target cell;
information used to indicate a slice supported by the target cell;
a system message of the target cell;
configuration information of the wakeup request;
a timing deviation between the service cell and the target cell; or configuration information used to identify whether to be close to the target cell.

It should be understood that the descriptions of various information in the configuration information of the target cell may refer to the relevant descriptions above, which will not be repeated herein to avoid a repetition.

S332, the terminal device transmits a wakeup request carrying identifier information of the target cell to the service cell.

Exemplarily, the identifier information includes a PCI of the target cell and a frequency point of the target cell.

Exemplarily, the identifier information includes a cell identifier of the target cell.

Exemplarily, when the terminal device is close to the target cell and the terminal device expects to wake up the target cell, the terminal device transmits the wakeup request to the target cell. Optionally, when beam quality of the service cell of the terminal device is greater than or equal to a first threshold value, and/or when signal quality of a synchronization signal and/or physical broadcast channel block (Synchronization Signal/PBCH Block, SSB) of the service cell is greater than or equal to a second threshold value, the terminal device determines that the terminal device is close to the target cell. When the priority of the frequency of the target cell is greater than the priority of the frequency of the service cell of the terminal device, and/or when the slice supported by the target cell is a slice expected by the terminal device, the terminal device determines that the terminal device expects to wake up the target cell.

Exemplarily, the configuration information of the wakeup request in the configuration information of the target cell includes information used to configure a time-frequency resource of the wakeup request, and the time-frequency resource of the wakeup request is a random access resource or a time-frequency domain resource configured separately for the wakeup request.

Exemplarily, configuration information used to identify whether to be close to the target cell, in the configuration information of the target cell may include: the first threshold value and the second threshold value.

S333, the service cell, after receiving the wakeup request from the terminal device, forwards the wakeup request to the target cell.

Exemplarily, after receiving the wakeup request, the service cell may directly forward the wakeup request to the target cell.

Exemplarily, after receiving the wakeup request, the service cell determines whether to forward the wakeup request to the target cell, and forwards the wakeup request to the target cell when determining to forward the wakeup request.

Exemplarily, the service cell may determine whether to forward the wakeup request to the target cell based on at least one of:
traffic volume of the service cell, a deployment location of the service cell, a deployment location of the target cell, a moment when the wakeup request is received, and a time period of a moment when the wakeup request is received.

It is worth noting that in the mobile communication network, the distribution of traffics varies with time. For example, there will be less traffics at night, more traffics during the day, and even less traffics at midnight. At the same time, the distribution of traffics is also related to the geographical area. For example, during the day, locations with a lot of office buildings have a higher volume of users, but have almost no user at night. However, in urban or residential areas, the traffic volume is very small during the daytime working time periods, but the traffic volume may be larger at night. In view of this, in the embodiments of the present disclosure, the service cell may determine whether to sleep or wake up the target cell according to the amount of the traffic volume. Since factors such as the deployment location of the target cell, the moment when the wakeup request is received, and the time period of the moment when the wakeup request is received, etc., can reflect the traffic volume of the service cell, by determining whether to forward the wakeup request to the target cell by considering factors such as the deployment location of the target cell, the moment when the wakeup request is received, and the time period of the moment when the wakeup request is received, etc., it can be implemented that the network deployment of the target cell can dynamically adjust its state, such as dynamically wake up or sleep the target cell or determine whether to wake up the target cell, according to the change in the traffic volume, which can achieve the purpose of network energy saving.

S334, the target cell, after receiving the wakeup request forwarded from the service cell, wakes up the target cell, that is, the target cell resumes to a normal cell state or a non-energy saving state.

Exemplarily, after receiving the wakeup request, the target cell may directly wake up the target cell.

S335a, the target cell transmits notification information to the service cell to indicate that the target cell has been woken up.

S335b, the target cell transmits a synchronization signal and a system message, etc., to the terminal device.

Exemplarily, the synchronization signal includes but is not limited to: a primary synchronization signal (Primary Synchronization Signal, PSS) and a secondary synchronization signal (Secondary Synchronization Signal, SSS).

Exemplarily, the system message includes but is not limited to: system information (System Information, SI), a master information block (Master Information Block, MIB), a system information block (System Information Block, SIB), and remaining system information (Remaining System Information, RMSI).

Exemplarily, after transmitting the wakeup request, the terminal device starts a timer with a duration of the first duration; if the timer times out, receives the synchronization signal and the system message transmitted by the target cell; and based on the synchronization signal and the system message, performs the cell selection operation and/or the cell reselection operation.

Of course, in other alternative embodiments, if there is a paging message of the terminal device, the terminal device may further receive the paging message after transmitting the wakeup request. For example, the paging message, the synchronization signal and the system message transmitted by the target cell are received simultaneously at the interval of the first duration after transmitting the wakeup request. In addition, the terminal device may also start to receive the synchronization signal and the system message directly after transmitting the wakeup request, and start the timer with a duration of the first duration after transmitting the wakeup request. In this case, if the timer times out, the cell selection operation and/or the cell reselection operation is performed. That is, the timer with a duration of the first duration may be used only to trigger the cell selection operation and/or the cell reselection operation, or may be also used to trigger the cell selection operation and/or the cell reselection operation on the basis of triggering the terminal device to receive the synchronization signal and the system message.

In this embodiment, the target cell is woken up by transmitting the wakeup request by the terminal device to the service cell, which can wake up the target cell in real time by the triggering of the terminal device on the basis of reducing the energy consumption of the target cell, thereby improving the flexibility of the target cell. In addition, after the target cell is woken up, the target cell transmits the notification information to the service cell, which can ensure that the service cell can know the state of the target cell in time, thereby avoiding a case where a communication failure occurs when the target cell is utilized to share the traffic volume of the service cell, and improving the communication performance.

### Embodiment 3

In this embodiment, when the target cell is in the energy saving state, the target cell is prohibited from performing an uplink reception or prohibited from receiving an uplink reception except a wakeup request for waking up the target cell, and the target cell is prohibited from transmitting a downlink transmission except a downlink discovery signal. In this case, the terminal device discovers the target cell by a downlink (DL) discovery signal, and wakes up the target cell by transmitting the wakeup request to the target cell.

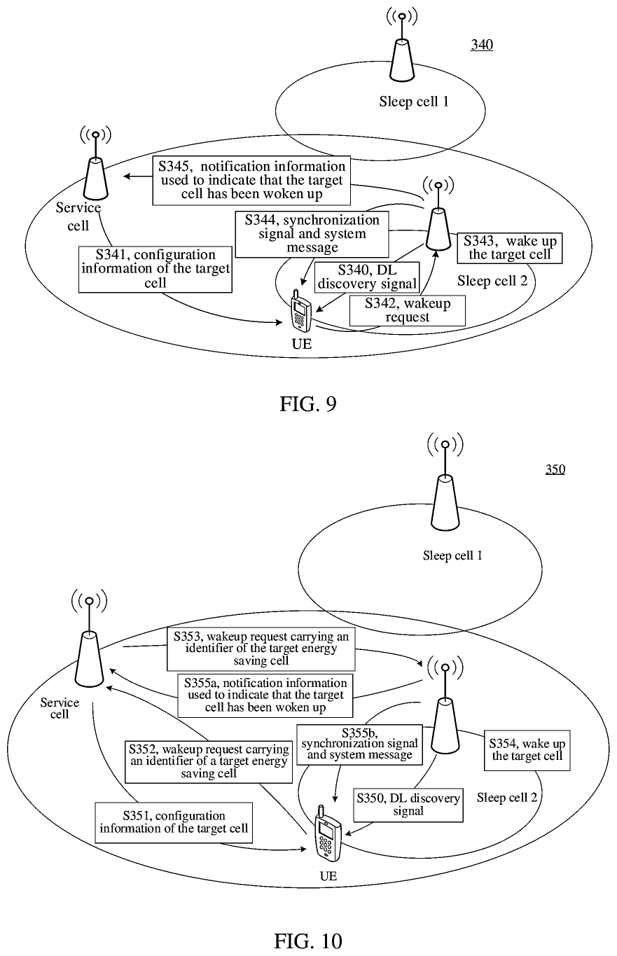

FIG. 9 is a schematic flowchart of a method 340 for waking up a target cell by transmitting a wakeup request to the target cell in a case of the presence of a downlink discovery signal, provided by the embodiments of the present disclosure.

As shown in FIG. 9, it is assumed that sleep cells that intersect with the coverage range of the service cell of the terminal device include a sleep cell 1 and a sleep cell 2. The following describes a method for waking up the dormant cell 2 by taking the dormant cell 2 as the target cell.

The method 340 may include: S340, the target cell transmits a downlink discovery signal.

Exemplarily, the downlink discovery signal may be an SSB, a CSI-RS or other downlink signals.

Exemplarily, the downlink discovery signal may also be a reference signal dedicated to discovering the target cell.

S341, the service cell of the terminal device transmits configuration information of the target cell to the terminal device.

Exemplarily, the configuration information of the target cell includes at least one of: information used to indicate a frequency point of the target cell;
information used to indicate a slice supported by the target cell;
a system message of the target cell;
configuration information of the wakeup request;
a timing deviation between the service cell and the target cell; or configuration information used to identify whether to be close to the target cell.

It should be understood that the descriptions of various information in the configuration information of the target cell may refer to the relevant descriptions above, which will not be repeated herein to avoid a repetition.

S342, the terminal device transmits a wakeup request to the target cell, where the wakeup request is used to request to wake up the target cell.

Exemplarily, the wakeup request requests to wake up the target cell by a ZC sequence or a preamble code.

Exemplarily, the ZC sequence used by the wakeup request is different from a ZC sequence used by the target cell, or a root sequence used to generate the ZC sequence used by the wakeup request is different from a root sequence used by a neighboring cell of the target cell.

Exemplarily, when the terminal device is close to the target cell, the quality of the downlink discovery signal meets the wakeup requirement, and the target cell and the terminal device expect to wake up the target cell, the wakeup request is transmitted. Optionally, when beam quality of the service cell of the terminal device is greater than or equal to a first threshold value, and/or when signal quality of a synchronization signal and/or physical broadcast channel block (Synchronization Signal/PBCH Block, SSB) of the service cell is greater than or equal to a second threshold value, the terminal device determines that the terminal device is close to the target cell. When the priority of the frequency of the target cell is greater than the priority of the frequency of the service cell of the terminal device, and/or when the slice supported by the target cell is a slice expected by the terminal device, the terminal device determines that the terminal device expects to wake up the target cell. Optionally, when the quality of the downlink discovery signal is greater than or equal to a third threshold value, the terminal device determines that quality of the downlink discovery signal meets the wakeup requirement.

Exemplarily, the configuration information of the wakeup request in the configuration information of the target cell includes information used to generate the wakeup request and/or information used to configure a time-frequency resource of the wakeup request, and the information used to generate the wakeup request includes at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

Exemplarily, configuration information used to identify whether to be close to the target cell, in the configuration information of the target cell may include: the first threshold value, the second threshold value, and the third threshold value.

S343, the target cell, after receiving the wakeup request from the terminal device, wakes up the target cell, that is, the target cell resumes to a normal cell state or a non-energy saving state.

Exemplarily, the target cell, after receiving the wakeup request, may directly wake up the target cell.

Exemplarily, the target cell, after receiving the wakeup request, determines whether to wake up the target cell, and wakes up the target cell when determining to wake up the target cell.

Exemplarily, the target cell may determine whether to wake up the target cell based on at least one of:
a deployment location of the target cell, a moment when the wakeup request is received, and a time period of a moment when the wakeup request is received.

It is worth noting that in the mobile communication network, the distribution of traffics varies with time. For example, there will be less traffics at night, more traffics during the day, and even less traffics at midnight. At the same time, the distribution of traffics is also related to the geographical area. For example, during the day, locations with a lot of office buildings have a higher volume of users, but have almost no user at night. However, in urban or residential areas, the traffic volume is very small during the daytime working time periods, but the traffic volume may be larger at night. In view of this, in the embodiments of the present disclosure, whether to sleep or wake up the target cell may be determined by the amount of the traffic volume. Furthermore, since when the target cell is in the energy saving state, the target cell does not know whether the current traffic volume is large or small, and factors such as the deployment location of the target cell, the moment when the wakeup request is received, and the time period of the moment when the wakeup request is received, etc., can reflect the traffic volume of the service cell, therefore, by determining whether to wake up the target cell by considering factors such as the deployment location of the target cell, the moment when the wakeup request is received, and the time period of the moment when the wakeup request is received, etc., it can be implemented that the network deployment of the target cell can dynamically adjust its state, such as dynamically wake up or sleep the target cell or determine whether to wake up the target cell, according to the change in the traffic volume, which can achieve the purpose of network energy saving.

S344, the target cell transmits a synchronization signal and a system message, etc., to the terminal device.

Exemplarily, the synchronization signal includes but is not limited to: a primary synchronization signal (Primary Synchronization Signal, PSS) and a secondary synchronization signal (Secondary Synchronization Signal, SSS).

Exemplarily, the system message includes but is not limited to: system information (System Information, SI), a master information block (Master Information Block, MIB), a system information block (System Information Block, SIB), and remaining system information (Remaining System Information, RMSI).

Exemplarily, after transmitting the wakeup request, the terminal device starts a timer with a duration of the first duration; if the timer times out, receives the synchronization signal and the system message transmitted by the target cell; and based on the synchronization signal and the system message, performs the cell selection operation and/or the cell reselection operation.

Of course, in other alternative embodiments, if there is a paging message of the terminal device, the terminal device may further receive the paging message after transmitting the wakeup request. For example, the paging message, the synchronization signal and the system message transmitted by the target cell are received simultaneously at the interval of the first duration after transmitting the wakeup request. In addition, the terminal device may also start to receive the synchronization signal and the system message directly after transmitting the wakeup request, and start the timer with a duration of the first duration after transmitting the wakeup request. In this case, if the timer times out, the cell selection operation and/or the cell reselection operation is performed. That is, the timer with a duration of the first duration may be used only to trigger the cell selection operation and/or the cell reselection operation, or may be also used to trigger the cell selection operation and/or the cell reselection operation on the basis of triggering the terminal device to receive the synchronization signal and the system message.

S345, the target cell transmits notification information to the service cell to indicate that the target cell has been woken up.

In this embodiment, the target cell is woken up by transmitting the wakeup request to the target cell by the terminal device, which can wake up the target cell in real time by the triggering of the terminal device on the basis of reducing the energy consumption of the target cell, thereby improving the flexibility of the target cell. In addition, after the target cell is woken up, the target cell transmits the notification information to the service cell, which can ensure that the service cell can know the state of the target cell in time, thereby avoiding a case where a communication failure occurs when the target cell is utilized to share the traffic volume of the service cell, and improving the communication performance.

### Embodiment 4

In this embodiment, when the target cell is in the energy saving state, the target cell is prohibited from performing an uplink reception or prohibited from receiving an uplink reception except a wakeup request for waking up the target cell, and the target cell is prohibited from transmitting a downlink transmission except a downlink discovery signal. In this case, the terminal device wakes up the target cell by transmitting a wakeup request to the target cell via the service cell of the terminal device.

FIG. 10 is a schematic flowchart of a method 330 for waking up a target cell by transmitting a wakeup request to a service cell in a case of the presence of a downlink discovery signal, provided by the embodiments of the present disclosure.

As shown in FIG. 10, it is assumed that sleep cells that intersect with the coverage range of the service cell of the terminal device include a sleep cell 1 and a sleep cell 2. The following describes a method for waking up the dormant cell 2 by taking the dormant cell 2 as the target cell.

The method 350 may include:
S350, the target cell transmits a downlink discovery signal.

Exemplarily, the downlink discovery signal may be an SSB, a CSI-RS or other downlink signals.

Exemplarily, the downlink discovery signal may also be a reference signal dedicated to discovering the target cell.

S351, the service cell of the terminal device transmits configuration information of the target cell to the terminal device.

Exemplarily, the configuration information of the target cell includes at least one of: information used to indicate a frequency point of the target cell;
information used to indicate a slice supported by the target cell;
a system message of the target cell;
configuration information of the wakeup request;
a timing deviation between the service cell and the target cell; or configuration information used to identify whether to be close to the target cell.

It should be understood that the descriptions of various information in the configuration information of the target cell may refer to the relevant descriptions above, which will not be repeated herein to avoid a repetition.

S352, the terminal device transmits a wakeup request carrying identifier information of the target cell to the service cell.

Exemplarily, the identifier information includes a PCI of the target cell and a frequency point of the target cell.

Exemplarily, the identifier information includes a cell identifier of the target cell.

Exemplarily, when the terminal device is close to the target cell, the quality of the downlink discovery signal meets the wakeup requirement, and the target cell and the terminal device expect to wake up the target cell, the wakeup request is transmitted. Optionally, when beam quality of the service cell of the terminal device is greater than or equal to a first threshold value, and/or when signal quality of a synchronization signal and/or physical broadcast channel block (Synchronization Signal/PBCH Block, SSB) of the service cell is greater than or equal to a second threshold value, the terminal device determines that the terminal device is close to the target cell. When the priority of the frequency of the target cell is greater than the priority of the frequency of the service cell of the terminal device, and/or when the slice supported by the target cell is a slice expected by the terminal device, the terminal device determines that the terminal device expects to wake up the target cell. Optionally, when the quality of the downlink discovery signal is greater than or equal to a third threshold value, the terminal device determines that quality of the downlink discovery signal meets the wakeup requirement.

Exemplarily, the configuration information of the wakeup request in the configuration information of the target cell includes information used to configure a time-frequency resource of the wakeup request, and the time-frequency resource of the wakeup request is a random access resource or a time-frequency domain resource configured separately for the wakeup request.

Exemplarily, configuration information used to identify whether to be close to the target cell, in the configuration information of the target cell may include: the first threshold value, the second threshold value, and the third threshold value.

S353, after receiving the wakeup request from the terminal device, the service cell forwards the wakeup request to the target cell.

Exemplarily, after receiving the wakeup request, the service cell may directly forward the wakeup request to the target cell.

Exemplarily, after receiving the wakeup request, the service cell determines whether to forward the wakeup request to the target cell, and forwards the wakeup request to the target cell when determining to forward the wakeup request.

Exemplarily, the service cell may determine whether to forward the wakeup request to the target cell based on at least one of:
traffic volume of the service cell, a deployment location of the service cell, a deployment location of the target cell, a moment when the wakeup request is received, and a time period of a moment when the wakeup request is received.

It is worth noting that in the mobile communication network, the distribution of traffics varies with time. For example, there will be less traffics at night, more traffics during the day, and even less traffics at midnight. At the same time, the distribution of traffics is also related to the geographical area. For example, during the day, locations with a lot of office buildings have a higher volume of users, but have almost no user at night. However, in urban or residential areas, the traffic volume is very small during the daytime working time periods, but the traffic volume may be larger at night. In view of this, in the embodiments of the present disclosure, the service cell may determine whether to sleep or wake up the target cell according to the amount of the traffic volume. Since factors such as the deployment location of the target cell, the moment when the wakeup request is received, and the time period of the moment when the wakeup request is received, etc., can reflect the traffic volume of the service cell, by determining whether to forward the wakeup request to the target cell by considering factors such as the deployment location of the target cell, the moment when the wakeup request is received, and the time period of the moment when the wakeup request is received, etc., it can be implemented that the network deployment of the target cell can dynamically adjust its state, such as dynamically wake up or sleep the target cell or determine whether to wake up the target cell, according to the change in the traffic volume, which can achieve the purpose of network energy saving.

S354, the target cell, after receiving the wakeup request forwarded from the service cell, wakes up the target cell, that is, the target cell resumes to a normal cell state or a non-energy saving state.

Exemplarily, the target cell, after receiving the wakeup request, may directly wake up the target cell.

S355a, the target cell transmits notification information to the service cell to indicate that the target cell has been woken up.

S355b, the target cell transmits a synchronization signal and a system message, etc., to the terminal device.

Exemplarily, the synchronization signal includes but is not limited to: a primary synchronization signal (Primary Synchronization Signal, PSS) and a secondary synchronization signal (Secondary Synchronization Signal, SSS).

Exemplarily, the system message includes but is not limited to: system information (System Information, SI), a master information block (Master Information Block, MIB), a system information block (System Information Block, SIB), and remaining system information (Remaining System Information, RMSI).

Exemplarily, after transmitting the wakeup request, the terminal device starts a timer with a duration of the first duration; if the timer times out, receives the synchronization signal and the system message transmitted by the target cell; and based on the synchronization signal and the system message, performs the cell selection operation and/or the cell reselection operation.

Of course, in other alternative embodiments, if there is a paging message of the terminal device, the terminal device may further receive the paging message after transmitting the wakeup request. For example, the paging message, the synchronization signal and the system message transmitted by the target cell are received simultaneously at the interval of the first duration after transmitting the wakeup request. In addition, the terminal device may also start to receive the synchronization signal and the system message directly after transmitting the wakeup request, and start the timer with a duration of the first duration after transmitting the wakeup request. In this case, if the timer times out, the cell selection operation and/or the cell reselection operation is performed. That is, the timer with a duration of the first duration may be used only to trigger the cell selection operation and/or the cell reselection operation, or may be also used to trigger the cell selection operation and/or the cell reselection operation on the basis of triggering the terminal device to receive the synchronization signal and the system message.

In this embodiment, the target cell is woken up by transmitting the wakeup request by the terminal device to the service cell, which can wake up the target cell in real time by the triggering of the terminal device on the basis of reducing the energy consumption of the target cell, thereby improving the flexibility of the target cell. In addition, after the target cell is woken up, the target cell transmits the notification information to the service cell, which can ensure that the service cell can know the state of the target cell in time, thereby avoiding a case where a communication failure occurs when the target cell is utilized to share the traffic volume of the service cell, and improving the communication performance.

The preferred implementations of the present disclosure are described in detail above in conjunction with the drawings; however, the present disclosure is not limited to the specific details in the implementations mentioned above. Within the scope of the technical concept of the present disclosure, multiple simple variants may be made to the technical solutions of the present disclosure, and these simple variants all fall within the protection scope of the present disclosure. For example, the various specific technical features described in the detailed description involved above may be combined in any suitable manner without contradiction. In order to avoid an unnecessary repetition, this disclosure will not further explain various possible combinations. For another example, the various different implementations of the present disclosure may be arbitrarily combined, and as long as the combined implementations do not violate the concept of the present disclosure, they should also be regarded as the contents disclosed in the present disclosure.

It should also be understood that in the various method embodiments of the present disclosure, the size of the sequence numbers of the processes involved above does not mean the order of execution. The order of execution of each process should be determined by its function and internal logic, and should not constitute any limitation on the implementation processes of the embodiments of the present disclosure.

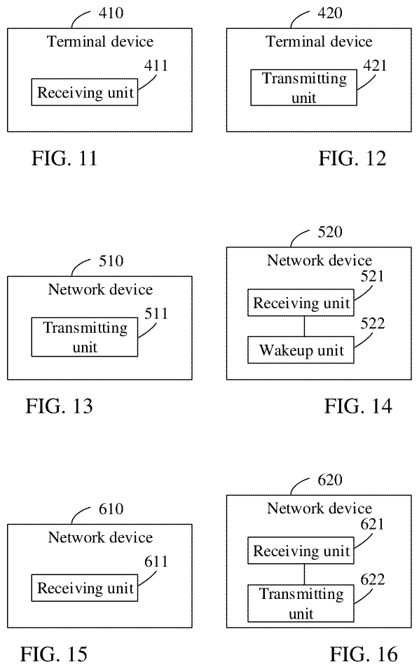

The method embodiments of the present disclosure are described in detail above, and apparatus embodiments of the present disclosure are described in detail below in conjunction with FIG. 11 to FIG. 18.

FIG. 11 is a schematic block diagram of a terminal device 410 of the embodiments of the present disclosure.

As shown in FIG. 11, the terminal device 410 may include:
a receiving unit 411, configured to receive first indication information transmitted by a target cell, where the first indication information is used to indicate that the target cell will enter an energy saving state.

In some embodiments, the terminal device is in a connected state; the receiving unit 411 is further configured to:
switch a service cell of the terminal device from the target cell to a neighboring cell of the target cell.

In some embodiments, the terminal device is in an inactive state or an idle state; the receiving unit 411 is further configured to:
perform a cell reselection operation.

In some embodiments, the first indication information is carried in a paging message, or the first indication information is carried in a changed system message, or the first indication information indicates, via a specific downlink signal, that the target cell will enter the energy saving state.

In some embodiments, in a case where the first indication information is carried in the changed system message, the receiving unit 411 is further configured to:
receive second indication information transmitted by the target cell, where the second indication information is used to indicate the terminal device to receive the changed system message.

In some embodiments, the first indication information includes at least one of:
information, used to indicate a frequency on which the terminal device preferentially resides;
duration information, used to indicate a duration between a moment when the terminal device receives the first indication information and a moment when the target cell enters the energy saving state; or
moment information, used to indicate a moment when the target cell enters the energy saving state.

In some embodiments, the moment information is used to indicate a target time unit, and the moment when the target cell enters the energy saving state is a start moment or an end moment of the target time unit.

In some embodiments, the energy saving state means: prohibiting the target cell from performing an uplink reception or prohibiting the target cell from receiving an uplink reception except a wakeup request for waking up the target cell, and prohibiting the target cell from performing a downlink transmission.

In some embodiments, the energy saving state means: prohibiting the target cell from performing an uplink reception or prohibiting the target cell from receiving an uplink reception except a wakeup request for waking up the target cell, and prohibiting the target cell from transmitting a downlink transmission except a downlink discovery signal.

In some embodiments, a coverage-type cell in which the target cell is located is a service cell of the terminal device, or the target cell is a capacity-type cell under a service cell of the terminal device.

FIG. 12 is a schematic block diagram of a terminal device 420 of the embodiments of the present disclosure.

As shown in FIG. 12, the terminal device 420 may include:
a transmitting unit 421, configured to transmit a wakeup request, where the wakeup request is used to request to wake up a target cell in an energy saving state.

In some embodiments, the transmitting unit 421 is specifically configured to:
transmit the wakeup request to the target cell.

In some embodiments, the wakeup request requests to wake up the target cell by a ZC sequence or a preamble code.

In some embodiments, the ZC sequence used by the wakeup request is different from a ZC sequence used by the target cell, or a root sequence used to generate the ZC sequence used by the wakeup request is different from a root sequence used by a neighboring cell of the target cell.

In some embodiments, the terminal device is in a connected state, and the transmitting unit 421 is specifically configured to:
transmit the wakeup request to a service cell of the terminal device.

In some embodiments, the wakeup request carries identifier information of the target cell.

In some embodiments, the identifier information includes at least one of: a physical cell identifier (PCI) of the target cell, a frequency point of the target cell, and a cell identifier of the target cell.

In some embodiments, the transmitting unit 421 is specifically configured to:
transmit the wakeup request, when the terminal device is close to the target cell and the terminal device expects to wake up the target cell.

In some embodiments, the transmitting unit 421 is further configured to:
determine that the terminal device is close to the target cell, when beam quality of a service cell of the terminal device is greater than or equal to a first threshold value, and/or, when signal quality of a synchronization signal and/or physical broadcast channel block (SSB) of the service cell is greater than or equal to a second threshold value.

In some embodiments, the transmitting unit 421 is further configured to:
determine that the terminal device expects to wake up the target cell, when a priority of a frequency of the target cell is greater than a priority of a frequency of a service cell of the terminal device, and/or when a slice supported by the target cell is a slice expected by the terminal device.

In some embodiments, the transmitting unit 421 is specifically configured to:
receive a downlink discovery signal transmitted by the target cell; and transmit the wakeup request, when the terminal device is close to the target cell, quality of the downlink discovery signal meets a wakeup requirement, and the target cell and the terminal device expect to wake up the target cell.

In some embodiments, the transmitting unit 421 is further configured to:
determine that the quality of the downlink discovery signal meets the wakeup requirement, when the quality of the downlink discovery signal is greater than or equal to a third threshold value.

In some embodiments, the energy saving state means: prohibiting the target cell from performing an uplink reception or prohibiting the target cell from receiving an uplink reception except the wakeup request, and prohibiting the target cell from performing a downlink transmission.

In some embodiments, the energy saving state means: prohibiting the target cell from performing an uplink reception or prohibiting the target cell from receiving an uplink reception except the wakeup request, and prohibiting the target cell from transmitting a downlink signal or downlink information except a downlink discovery signal.

In some embodiments, the transmitting unit 421 is further configured to:
perform a cell selection operation and/or a cell reselection operation at an interval of a first duration after transmitting the wakeup request.

In some embodiments, the transmitting unit 421 is specifically configured to:
after transmitting the wakeup request, start a timer with a duration equal to the first duration;
if the timer times out, perform the cell selection operation and/or the cell reselection operation.

In some embodiments, the first duration is determined by the terminal device, or the first duration is a duration configured by a network device, or the first duration is a predefined duration, or the first duration depends on an implementation of the terminal device.

In some embodiments, the transmitting unit 421 is specifically configured to:
receive a synchronization signal and a system message transmitted by the target cell, at the interval of the first duration after transmitting the wakeup request;
perform the cell selection operation and/or the cell reselection operation based on the synchronization signal and the system message.

In some embodiments, the transmitting unit 421 is further configured to:
receive configuration information of the target cell transmitted by a service cell of the terminal device, where the configuration information of the target cell includes at least one of: information used to indicate a frequency point of the target cell;
information used to indicate a slice supported by the target cell;
a system message of the target cell;
configuration information of the wakeup request;
a timing deviation between the service cell and the target cell; or configuration information used to identify whether to be close to the target cell.

In some embodiments, the configuration information of the wakeup request includes information used to generate the wakeup request and/or information used to configure a time-frequency resource of the wakeup request, and the information used to generate the wakeup request includes at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

In some embodiments, the configuration information used to identify whether to be close to the target cell, includes at least one of: an identifier of a beam of the service cell, an identifier of an SSB of the service cell, a threshold value corresponding to the identifier of the beam of the service cell, or a threshold value corresponding to the identifier of the SSB of the service cell.

In some embodiments, a coverage-type cell in which the target cell is located is a service cell of the terminal device, or the target cell is a capacity-type cell under a service cell of the terminal device.

It should be understood that the apparatus embodiments and the method embodiments may correspond to each other, and similar descriptions of the apparatus embodiments may refer to the method embodiments. Specifically, the terminal device 410 shown in FIG. 11 and the terminal device 420 shown in FIG. 12 may correspond to the corresponding subjects performing the various method embodiments of the present disclosure, and the aforementioned and other operations and/or functions of the various units in the terminal device 410 and the terminal device 420 are respectively to implement the corresponding procedures in the various methods provided by the embodiments of the present disclosure, which will not be repeated here for the sake of brevity.

FIG. 13 is a schematic block diagram of a network device 510 of the embodiments of the present disclosure.

As shown in FIG. 13, the network device 510 is configured to provide a target cell, and the network device 510 may include:
a transmitting unit 511, configured to transmit first indication information to a terminal device, where the first indication information is used to indicate that the target cell will enter an energy saving state.

In some embodiments, the first indication information is carried in a paging message, or the indication information is carried in a changed system message, or the first indication information indicates, via a specific downlink signal, that the target cell will enter the energy saving state.

In some embodiments, in a case where the first indication information is carried in the changed system message, the transmitting unit 511 is further configured to:
transmit second indication information to the terminal device, where the second indication information is used to indicate the terminal device to receive the changed system message.

In some embodiments, the first indication information includes at least one of:
information, used to indicate a frequency on which the terminal device preferentially resides;
duration information, used to indicate a duration between a moment when the terminal device receives the first indication information and a moment when the target cell enters the energy saving state; or
moment information, used to indicate a moment when the target cell enters the energy saving state.

In some embodiments, the moment information is used to indicate a target time unit, and the moment when the target cell enters the energy saving state is a start moment or an end moment of the target time unit.

In some embodiments, the transmitting unit 511 is further configured to:
transmit configuration information of the target cell to a service cell of the terminal device, where the configuration information of the target cell includes at least one of: information used to indicate a frequency point of the target cell;
information used to indicate a slice supported by the target cell;
a system message of the target cell;
information configured for a wakeup request for waking up the target cell;
a timing deviation between the service cell and the target cell; or information used to identify whether to be close to the target cell.

In some embodiments, the information configured for the wakeup request for waking up the target cell includes information used to generate the wakeup request and/or information used to configure a time-frequency resource of the wakeup request, and the information used to generate the wakeup request includes at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

In some embodiments, the information used to identify whether to be close to the target cell includes at least one of: an identifier of a beam of the service cell, an identifier of an SSB of the service cell, a threshold value corresponding to the identifier of the beam of the service cell, or a threshold value corresponding to the identifier of the SSB of the service cell.

In some embodiments, the energy saving state means: prohibiting the target cell from performing an uplink reception or prohibiting the target cell from receiving an uplink reception except a wakeup request for waking up the target cell, and prohibiting the target cell from performing a downlink transmission.

In some embodiments, the energy saving state means: prohibiting the target cell from performing an uplink reception or prohibiting the target cell from receiving an uplink reception except a wakeup request for waking up the target cell, and prohibiting the target cell from transmitting a downlink transmission except a downlink discovery signal.

In some embodiments, a coverage-type cell in which the target cell is located is a service cell of the terminal device, or the target cell is a capacity-type cell under a service cell of the terminal device.

FIG. 14 is a schematic block diagram of a network device 520 of the embodiments of the present disclosure.

As shown in FIG. 14, the network device 520 is configured to provide a target cell, and the network device 520 may include:
a receiving unit 521, configured to receive a wakeup request, where the wakeup request is used to request to wake up the target cell in an energy saving state; and
a wakeup unit 522, configured to wake up the target cell based on the wakeup request.

In some embodiments, the receiving unit 521 is specifically configured to:
receive the wakeup request transmitted by a terminal device.

In some embodiments, the wakeup request requests to wake up the target cell by a ZC sequence or a preamble code.

In some embodiments, the ZC sequence used by the wakeup request is different from a ZC sequence used by the target cell, or a root sequence used to generate the ZC sequence used by the wakeup request is different from a root sequence used by a neighboring cell of the target cell.

In some embodiments, the receiving unit 521 is specifically configured to:
receive the wakeup request forwarded by a neighboring cell of the target cell.

In some embodiments, the wakeup request carries identifier information of the target cell.

In some embodiments, the identifier information includes at least one of: a physical cell identifier (PCI) of the target cell, a frequency point of the target cell, and a cell identifier of the target cell.

In some embodiments, the wakeup unit 522 is further configured to:
transmit notification information to a neighboring cell of the target cell, where the notification information is used to indicate that the target cell has been woken up.

In some embodiments, the wakeup unit 522 is further configured to:
transmit a synchronization signal and a system message transmitted by the target cell.

In some embodiments, the wakeup unit 522 is further configured to:
determine whether to wake up the target cell.

In some embodiments, the wakeup unit 522 is specifically configured to:
determine whether to wake up the target cell based on at least one of:
a deployment location of the target cell, a moment when the wakeup request is received, and a time period of a moment when the wakeup request is received.

In some embodiments, the energy saving state means: prohibiting the target cell from performing an uplink reception or prohibiting the target cell from receiving an uplink reception except the wakeup request, and prohibiting the target cell from performing a downlink transmission.

In some embodiments, the energy saving state means: prohibiting the target cell from performing an uplink reception or prohibiting the target cell from receiving an uplink reception except the wakeup request, and prohibiting the target cell from transmitting a downlink transmission except a downlink discovery signal.

In some embodiments, the receiving unit 521 is further configured to:
transmit the downlink discovery signal to the terminal device.

In some embodiments, a coverage-type cell in which the target cell is located is a service cell of a terminal device, or the target cell is a capacity-type cell under a service cell of the terminal device.

FIG. 15 is a schematic block diagram of a network device 610 of the embodiments of the present disclosure.

As shown in FIG. 15, the network device 610 is configured to provide a service cell for a terminal device, and the network device 610 may include:
a receiving unit 611 is used to receive configuration information of a target cell transmitted by the target cell, where the configuration information of the target cell includes at least one of:
information used to indicate a frequency point of the target cell;
information used to indicate a slice supported by the target cell;
a system message of the target cell;
information configured for a wakeup request for waking up the target cell;
a timing deviation between the service cell and the target cell; or information used to identify whether to be close to the target cell.

In some embodiments, the information configured for the wakeup request for waking up the target cell includes information used to generate the wakeup request and/or information used to configure a time-frequency resource of the wakeup request, and the information used to generate the wakeup request includes at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

In some embodiments, the information used to identify whether to be close to the target cell includes at least one of: an identifier of a beam of the service cell, an identifier of an SSB of the service cell, a threshold value corresponding to the identifier of the beam of the service cell, or a threshold value corresponding to the identifier of the SSB of the service cell.

In some embodiments, the receiving unit 611 is further configured to:
forward the configuration information of the target cell to the terminal device.

In some embodiments, the energy saving state means: prohibiting the target cell from performing an uplink reception or prohibiting the target cell from receiving an uplink reception except the wakeup request, and prohibiting the target cell from performing a downlink transmission.

In some embodiments, the energy saving state means: prohibiting the target cell from performing an uplink reception or prohibiting the target cell from receiving an uplink reception except the wakeup request, and prohibiting the target cell from transmitting a downlink transmission except a downlink discovery signal.

In some embodiments, a coverage-type cell in which the target cell is located is the service cell of the terminal device, or the target cell is a capacity-type cell under the service cell of the terminal device.

FIG. 16 is a schematic block diagram of a network device 620 of the embodiments of the present disclosure.

As shown in FIG. 16, the network device 620 is configured to provide a service cell for a terminal device, and the network device 620 may include:
a receiving unit 621, configured to receive a wakeup request transmitted by the terminal device, where the wakeup request is used to request to wake up a target cell in an energy saving state;
a transmitting unit 622, configured to forward the wakeup request to the target cell.

In some embodiments, the wakeup request carries identifier information of the target cell.

In some embodiments, the identifier information includes at least one of: a physical cell identifier (PCI) of the target cell, a frequency point of the target cell, and a cell identifier of the target cell.

In some embodiments, the receiving unit 621 is specifically configured to:
receive notification information transmitted by the target cell, where the notification information is used to indicate that the target cell has been woken up.

In some embodiments, the transmitting unit 622 is further configured to:
determine whether to forward the wakeup request to the target cell.

In some embodiments, the transmitting unit 622 is specifically configured to:
determine whether to forward the wakeup request to the target cell based on at least one of:
traffic volume of the service cell, a deployment location of the service cell, a deployment location of the target cell, a moment when the wakeup request is received, and a time period of a moment when the wakeup request is received.

In some embodiments, the energy saving state means: prohibiting the target cell from performing an uplink reception or prohibiting the target cell from receiving an uplink reception except the wakeup request, and prohibiting the target cell from performing a downlink transmission.

In some embodiments, the energy saving state means: prohibiting the target cell from performing an uplink reception or prohibiting the target cell from receiving an uplink reception except the wakeup request, and prohibiting the target cell from transmitting a downlink transmission except a downlink discovery signal.

In some embodiments, the transmitting unit 622 is further configured to:
transmit configuration information of the target cell to the terminal device, where the configuration information of the target cell includes at least one of:
information used to indicate a frequency point of the target cell;
information used to indicate a slice supported by the target cell;
a system message of the target cell;
configuration information of the wakeup request;
a timing deviation between the service cell and the target cell; or configuration information used to identify whether to be close to the target cell.

In some embodiments, the configuration information of the wakeup request includes information used to generate the wakeup request and/or information used to configure a time-frequency resource of the wakeup request, and the information used to generate the wakeup request includes at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

In some embodiments, the configuration information used to identify whether to be close to the target cell, includes at least one of: an identifier of a beam of the service cell, an identifier of an SSB of the service cell, a threshold value corresponding to the identifier of the beam of the service cell, or a threshold value corresponding to the identifier of the SSB of the service cell.

In some embodiments, a coverage-type cell in which the target cell is located is the service cell of the terminal device, or the target cell is a capacity-type cell under the service cell of the terminal device.

It should be understood that the apparatus embodiments and the method embodiments may correspond to each other, and similar descriptions of the apparatus embodiments may refer to the method embodiments. Specifically, the network device 510 shown in FIG. 13, the network device 520 shown in FIG. 14, the network device 610 shown in FIG. 15, and the network device 620 shown in FIG. 16 may correspond to the corresponding subjects performing the various method embodiments provided by the present disclosure, and the aforementioned and other operations and/or functions of the various units in the network device 510, the network device 520, the network device 610, and the network device 620 are respectively to implement the corresponding procedures in the various methods provided by the embodiments of the present disclosure, which will not be repeated here for the sake of brevity.

The communication devices of the embodiments of the present disclosure are described above from the perspective of functional modules in combination with the drawings. It should be understood that the functional module may be implemented in the form of hardware, or may also be implemented by instructions in the form of software, or may also be implemented by a combination of a hardware module and a software module. Specifically, each step of the method embodiments in the embodiments of the present disclosure may be completed by a hardware integrated logic circuit and/or software instructions in a processor. The steps of the methods disclosed in conjunction with the embodiments of the present disclosure may be directly implemented as being executed and completed by a hardware coding processor, or being executed and completed by a combination of a hardware module and a software module in the coding processor. Optionally, the software module may be located in a mature storage medium in the art, such as a random access memory, a flash memory, a read-only memory, a programmable read-only memory, an electrically erasable programmable memory, a register, or the like. The storage medium is located in the memory, and the processor reads the information in the memory, and completes the steps in the method embodiments involved above in combination with its hardware.

For example, the receiving units and the transmitting units involved above may be implemented by a transceiver, and the wakeup unit involved above may be implemented by the processor.

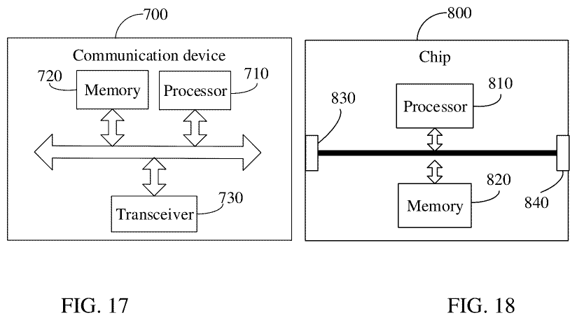

FIG. 17 is a schematic structural diagram of a communication device 700 of the embodiments of the present disclosure.

As shown in FIG. 17, the communication device 700 may include a processor 710.

The processor 710 may call and run a computer program from a memory, to implement the method in the embodiments of the present disclosure.

As shown in FIG. 17, the communication device 700 may further include a memory 720.

Herein, the memory 720 may be configured to store indication information, and may also be configured to store codes and instructions executed by the processor 710. Herein, the processor 710 may call the computer program from the memory 720 and run the computer program, to implement the method in the embodiments of the present disclosure. The memory 720 may be a separate device independent of the processor 710, or may also be integrated into the processor 710.

As shown in FIG. 17, the communication device 700 may further include a transceiver 730.

Herein, the processor 710 may control the transceiver 730 to communicate with other devices, and specifically, control the transceiver 730 to be able to transmit information or data to other devices, or receive information or data transmitted by other devices. The transceiver 730 may include a transmitter and a receiver. The transceiver 730 may further include an antenna, and the number of antennas may be one or more.

It should be understood that the various components in the communication device 700 are connected with each other via a bus system, where the bus system includes not only a data bus but also a power bus, a control bus and a status signal bus.

It should also be understood that the communication device 700 may be the terminal device of the embodiments of the present disclosure, and the communication device 700 may implement the corresponding procedures implemented by the terminal device in the various methods of the embodiments of the present disclosure. That is, the communication device 700 of the embodiments of the present disclosure may correspond to the terminal device 410 or the terminal device 420 in the embodiments of the present disclosure, and may correspond to the corresponding subjects performing the various methods provided by the embodiments of the present disclosure, which will not be repeated here for the sake of brevity. Similarly, the communication device 700 may be the network device in the embodiments of the present disclosure, and the communication device 700 may implement the corresponding procedures implemented by the network device in various methods in the embodiments of the present disclosure. That is, the communication device 700 of the embodiments of the present disclosure may correspond to the network device 510, the network device 520, the network device 610 and the network device 620 in the embodiments of the present disclosure, and may correspond to the corresponding subjects performing the various methods provided by the embodiments of the present disclosure, which will not be repeated here for the sake of brevity.

In addition, a chip is also provided by the embodiments of the present disclosure.

For example, the chip may be an integrated circuit chip with a signal processing capability, and may implement or perform the methods, steps and logic block diagrams disclosed in the embodiments of the present disclosure. The chip may also be referred to as a system-level chip, a system chip, a chip system, or a system-on-chip chip, etc. Optionally, the chip may be applied to various communication devices to cause the communication devices equipped with the chip to perform the methods, steps and logic block diagrams disclosed in the embodiments of the present disclosure.

FIG. 18 is a schematic structural diagram of a chip 800 according to the embodiments of the present disclosure.

As shown in FIG. 18, the chip 800 includes a processor 810.

Herein, the processor 810 may call a computer program from a memory and run the computer program, to implement the method in the embodiments of the present disclosure.

As shown in FIG. 18, the chip 800 may further include a memory 820.

Herein, the processor 810 may call a computer program from the memory 820 and run the computer program, to implement the method in the embodiments of the present disclosure. The memory 820 may be configured to store indication information, and may also be configured to store codes, instructions, etc., performed by the processor 810. The memory 820 may be a separate device independent of the processor 810, or may also be integrated into the processor 810.

As shown in FIG. 18, the chip 800 may further include an input interface 830.

Herein, the processor 810 may control the input interface 830 to communicate with other devices or chips, and specifically, control the input interface 830 to be able to acquire information or data transmitted by other devices or chips.

As shown in FIG. 18, the chip 800 may further include an output interface 840.

The processor 810 may control the output interface 840 to communicate with other devices or chips, and specifically, control the input interface 830 to be able to output information or data to other devices or chips.

It should be understood that the chip 800 may be applied to the network device in the embodiments of the present disclosure, and the chip can implement the corresponding procedures implemented by the network device in the various methods of the embodiments of the present disclosure, and may also implement the corresponding procedures implemented by the terminal device in the various methods of the embodiments of the present disclosure, which will not be repeated here for the sake of brevity. It should also be understood that the various components in the chip 800 are connected with each other via a bus system, where the bus system includes not only a data bus but also a power bus, a control bus and a status signal bus.

The processor mentioned above may include but are not limited to:
a general purpose processor, digital signal processor (Digital Signal Processor, DSP), application specific integrated circuit (Application Specific Integrated Circuit, ASIC), field programmable gate array (Field Programmable Gate Array, FPGA) or other programmable logic devices, discrete component gate or transistor logic device, discrete hardware component, etc.

The processor may be configured to implement or perform the methods, steps and logic block diagrams disclosed in the embodiments of the present disclosure. The steps of the methods disclosed in conjunction with the embodiments of the present disclosure may be directly implemented as being executed and completed by a hardware coding processor, or being executed and completed by a combination of a hardware module and a software module in the coding processor. The software module may be located in a mature storage medium in the art, such as a random access memory, a flash memory, a read-only memory, a programmable read-only memory, an erasable programmable memory, a register, or the like. The storage medium is located in the memory, and the processor reads the information in the memory, and completes the steps of the methods involved above in combination with its hardware.

The memory involved above includes but is not limited to:
a volatile memory and/or a non-volatile memory. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory.

The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (synch link DRAM, SLDRAM) and a direct rambus random access memory (Direct Rambus RAM, DR RAM).

It should be noted that the memory described herein is intended to include these and any other suitable types of memory.

A non-transitory computer-readable storage medium is also provided by the embodiments of the present disclosure to store a computer program. The non-transitory computer-readable storage medium stores one or more programs, and the one or more programs include instructions. The instructions, when executed by a portable electronic device including multiple application programs, can cause the portable electronic device to perform the wireless communication method provided by the present disclosure. Optionally, the non-transitory computer-readable storage medium may be applied to the network device in the embodiments of the present disclosure, and the computer program causes the computer to perform the corresponding procedures implemented by the network device in the various methods of the embodiments of the present disclosure, which will not be repeated here for the sake of brevity. Optionally, the non-transitory computer-readable storage medium may be applied to the mobile terminal/terminal device in the embodiments of the present disclosure, and the computer program causes the computer to perform the corresponding procedures implemented by the mobile terminal/terminal device in the various methods of the embodiments of the present disclosure, which will not be repeated here for the sake of brevity.

A computer program product is also provided by the embodiments of the present disclosure, including a computer program. Optionally, the computer program product may be applied to the network device in the embodiments of the present disclosure, and the computer program causes a computer to perform the corresponding procedures implemented by the network device in the various methods of the embodiments of the present disclosure, which will not be repeated here for the sake of brevity. Optionally, the computer program product may be applied to the mobile terminal/terminal device in the embodiments of the present disclosure, and the computer program causes a computer to perform the corresponding procedures implemented by the mobile terminal/terminal device in various methods of the embodiments of the present disclosure, which will not be repeated here for the sake of brevity.

A computer program is also provided by the embodiments of the present disclosure. The computer program, when executed by a computer, causes the computer to perform the wireless communication method provided by the present disclosure. Optionally, the computer program may be applied to the network device in the embodiments of the present disclosure, the computer program when being executed on a computer, causes the computer to perform the corresponding procedures implemented by the network device in various methods of the embodiments of the present disclosure, which will not be repeated here for the sake of brevity. Optionally, the computer program may be applied to the mobile terminal/terminal device in the embodiments of the present disclosure, the computer program when being executed on a computer, causes the computer to perform the corresponding procedures implemented by the mobile terminal/terminal device in various methods of the embodiments of the present disclosure, which will not be repeated here for the sake of brevity.

The present disclosure also provides a communication system, which may include the terminal device and the network device mentioned above, to form the communication system 100 as shown in FIG. 1, which will not be repeated here for the sake of brevity. It should be noted that the term “system”, etc., herein may also be referred to as a “network management architecture” or “network system” and so on.

It should also be understood that the terms used in the embodiments and the appended claims of the present disclosure are for the purpose of describing specific embodiments only, and are not intended to limit the embodiments of the present disclosure. For example, the singular forms “a” “said” “above” and “the” as used in the embodiments and the appended claims of the present disclosure, are intended to include the plural forms as well, unless the context clearly indicates other meanings.

Those skilled in the art may be aware that units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the embodiments of the present disclosure. If implemented in the form of a software functional unit and sold or used as an independent product, they may be stored in a computer-readable storage medium. Based on this understanding, the technical solutions of the embodiments of the present disclosure essentially, or a part of the technical solutions that contributes to the prior art, or a part of the technical solutions, may be embodied in the form of a software product, and the computer software product is stored in a storage medium, and includes a plurality of instructions for enabling a computer device (which may be a personal computer, a server, or a network device, etc.) to perform all or some of steps of the methods described in the embodiments of the present disclosure. In addition, the storage medium mentioned above includes: various mediums that may store program codes, such as a U disk, a mobile hard disk, a read-only memory, a random access memory, a diskette, or an optical disk.

Those skilled in the art may also be aware that, for the convenience and brevity of the description, the specific working processes of the system, apparatus and unit described above may refer to the corresponding processes in the aforementioned method embodiments, which will not be repeated here. In several embodiments provided by this disclosure, it should be understood that the disclosed system, apparatus and method may be implemented in other ways. For example, the division of units or modules or components in the apparatus embodiments described above is only a logical function division, and there may be other division methods in actual implementations. For example, multiple units or modules or components may be combined or integrated into another system, or some units or modules or components may be ignored or not executed. For another example, the units/modules/components described above as separate/displayed components may be or may not be physically separated, that is, they may be located in one place, or may be distributed over multiple network units. Some or all of the units/modules/components may be selected according to actual needs to achieve the purpose of the embodiments of the present disclosure. Finally, it should be noted that the coupling or direct coupling or communicative connection between each other as shown or discussed above may be indirect coupling or communicative connection of apparatus or units via some interfaces, which may be electrical, mechanical, or in other forms.

The above contents are only specific implementations of the present disclosure, but the protection scope of the embodiments of the present disclosure is not limited thereto, and any skilled familiar with this technical field may easily think of changes or substitutions within the technical scope disclosed in the embodiments of the present disclosure, which should be all covered within the protection scope of the embodiments of the present disclosure. Therefore, the protection scope of the embodiments of the present disclosure should be subject to the protection scope of the claims.

What is claimed is:

1. A network energy saving method, wherein the method is applicable to a terminal device, and the method comprises:
receiving first indication information transmitted by a target cell, wherein the first indication information is used to indicate that the target cell will enter an energy saving state.

2. The method according to claim 1, wherein the terminal device is in a connected state; and the method further comprises:
switching a service cell of the terminal device from the target cell to a neighboring cell of the target cell.

3. The method according to claim 1, wherein the terminal device is in an inactive state or an idle state; and the method further comprises:
performing a cell reselection operation.

4. The method according to claim 1, wherein the first indication information comprises: information used to indicate a frequency on which the terminal device preferentially resides.

5. A cell wakeup method, wherein the method is applicable to a terminal device, and the method comprises:
transmitting a wakeup request, wherein the wakeup request is used to request to wake up a target cell in an energy saving state.

6. The method according to claim 5, wherein transmitting the wakeup request comprises:
transmitting the wakeup request to the target cell.

7. The method according to claim 6, wherein the wakeup request requests to wake up the target cell by a ZC sequence or a preamble code.

8. The method according to claim 5, wherein transmitting the wakeup request comprises:
transmitting the wakeup request, when the terminal device is close to the target cell and the terminal device expects to wake up the target cell.

9. The method according to claim 8, further comprising:
determining that the terminal device is close to the target cell, when beam quality of a service cell of the terminal device is greater than or equal to a first threshold value, and/or, when signal quality of a synchronization signal and/or physical broadcast channel block (SSB) of the service cell is greater than or equal to a second threshold value.

10. The method according to claim 8, wherein transmitting the wakeup request, when the terminal device is close to the target cell and the terminal device expects to wake up the target cell, comprises:
receiving a downlink discovery signal transmitted by the target cell; and
transmitting the wakeup request, when the terminal device is close to the target cell, quality of the downlink discovery signal meets a wakeup requirement, and the target cell and the terminal device expect to wake up the target cell.

11. The method according to claim 10, further comprising:
determining that the quality of the downlink discovery signal meets the wakeup requirement, when the quality of the downlink discovery signal is greater than or equal to a third threshold value.

12. The method according to claim 5, further comprising:
performing a cell selection operation and/or a cell reselection operation at an interval of a first duration after transmitting the wakeup request.

13. The method according to claim 12, wherein performing the cell selection operation and/or the cell reselection operation at the interval of the first duration after transmitting the wakeup request, comprises:
after transmitting the wakeup request, starting a timer with a duration equal to the first duration;
if the timer times out, performing the cell selection operation and/or the cell reselection operation.

14. The method according to claim 12, wherein performing the cell selection operation and/or the cell reselection operation at the interval of the first duration after transmitting the wakeup request, comprises:
receiving a synchronization signal and a system message transmitted by the target cell, at the interval of the first duration after transmitting the wakeup request;
performing the cell selection operation and/or the cell reselection operation based on the synchronization signal and the system message.

15. The method according to claim 5, further comprising:
receiving configuration information of the target cell transmitted by a service cell of the terminal device, wherein the configuration information of the target cell comprises at least one of:
information used to indicate a frequency point of the target cell;
information used to indicate a slice supported by the target cell; or
configuration information of the wakeup request.

16. The method according to claim 15, wherein the configuration information of the wakeup request comprises information used to generate the wakeup request and/or information used to configure a time-frequency resource of the wakeup request, and the information used to generate the wakeup request comprises at least one of: an identifier of a ZC sequence used by the wakeup request, an identifier of a preamble code used by the wakeup request, an identifier of a root sequence used to generate the ZC sequence or to generate the preamble code, or the time-frequency resource of the wakeup request being a random access resource or a time-frequency domain resource configured separately for the wakeup request.

17. The method according to claim 15, wherein the configuration information used to identify whether to be close to the target cell, comprises at least one of: an identifier of a beam of the service cell, an identifier of an SSB of the service cell, a threshold value corresponding to the identifier of the beam of the service cell, or a threshold value corresponding to the identifier of the SSB of the service cell.

18. A network device, wherein the network device is configured to provide a target cell and comprises:
a transceiver, a processor and a memory, wherein the memory is configured to store a computer program, and the processor is configured to call and run the computer program stored in the memory, to cause the transceiver to perform:
transmitting first indication information to a terminal device, wherein the first indication information is used to indicate that the target cell will enter an energy saving state.

19. The network device according to claim 18, wherein the first indication information comprises:
information used to indicate a frequency on which the terminal device preferentially resides.

20. A terminal device, comprising:
a transceiver, a processor and a memory, wherein the memory is configured to store a computer program, and the processor is configured to call and run the computer program stored in the memory, to cause the transceiver and/or the processor to perform the method according to claim 1.
